(19) United States
(12) Patent Application Publication
(10) Pub. No.: US 2019/0197996 A1
(43) Pub. Date: Jun. 27, 2019

(54) DISPLAY DEVICE

(71) Applicant: Japan Display Inc., Tokyo (JP)

(72) Inventor: Yutaka Mitsuzawa, Tokyo (JP)

(21) Appl. No.: 16/227,067

(22) Filed: Dec. 20, 2018

(30) Foreign Application Priority Data
Dec. 25, 2017 (JP) 2017-248188

(51) Int. Cl. G09G 5/399

(52) U.S. Cl. CPC G09G 5/399; G09G 2360/12

(57) ABSTRACT

A display device includes: a display area including partial display areas; sub-pixels, each sub-pixel including a memory block with memories to store sub-pixel data; memory selection line groups, each of which is provided in each row or column in each partial display area and includes memory selection lines, each memory selection line electrically being coupled to the memory blocks, each of which belongs to the sub-pixels arranged in the row or the column; a memory selection control circuit for one of the memory selection lines from each memory selection line group, the memory selection lines selected functioning as an output destination of a memory selection signal for selecting one of the memories in the memory block; a memory selection circuit outputting the memory selection signal; and distribution circuits outputting the memory selection signal to the selected one of the memory selection lines in each memory selection line group.

### CROSS-REFERENCE TO RELATED APPLICATIONS

This application claims priority from Japanese Application No. 2017-248188, filed on Dec. 25, 2017, the contents of which are incorporated by reference herein in its entirety.

### BACKGROUND

### 1. Technical Field

The present disclosure relates to a display device.

### 2. Description of the Related Art

A display device for displaying images includes a plurality of pixels. Japanese Patent Application Laid-open Publication No. 9-212140 (JP-A-9-212140) describes what is called a memory-in-pixel (MIP) display device. This display device includes a plurality of pixels, with each pixel including a plurality of memories and a switching circuit for switching between the memories. This display device performs moving image display in which an object moves on a background by switching between the memories in each of the pixels displaying the moving object.

With the display device described in JP-A-9-212140, switching between the memories of each pixel is performed by using line-sequential scanning that is performed by the switching circuit in accordance with a scan signal. Accordingly, this display device requires one frame time to switch between the memories in each of the pixels. In other words, this display device requires one frame time to change an image (frame).

For the foregoing reasons, there is a need for a display device capable of changing an image in a short period of time.

### SUMMARY

According to an aspect, a display device includes: a display area including a plurality of partial display areas; a plurality of sub-pixels arranged in a row direction and a column direction in each of the partial display areas, each of the sub-pixels comprising a memory block with a plurality of memories configured to store sub-pixel data; a plurality of memory selection line groups, each of which is provided in each row or column in each of the partial display areas and comprises a plurality of memory selection lines, each of the memory selection lines electrically being coupled to the memory blocks, each of which belongs to the sub-pixels arranged in the row or the column; a memory selection control circuit configured to select, based on a set value, one of the memory selection lines from each of the memory selection line groups, the memory selection lines selected functioning as an output destination of a memory selection signal, the memory selection signal for one of the memories in the memory block; a memory selection circuit configured to output the memory selection signal based on the selection made by the memory selection control circuit; and a plurality of distribution circuits coupled to the memory selection line groups and configured to output the memory selection signal, which is output from the memory selection circuit, to the selected one of the memory selection lines in each of the memory selection line groups.

### BRIEF DESCRIPTION OF THE DRAWINGS

FIG. 1 is a diagram illustrating an overview of an overall configuration of a display device according to a first embodiment of the present disclosure;

FIG. 2 is a diagram illustrating a sectional structure of the display device according to the first embodiment;

FIG. 3 is a diagram illustrating an arrangement of sub-pixels in a pixel of the display device according to the first embodiment;

FIG. 4 is a diagram illustrating a circuit configuration of a frequency dividing circuit and a selection circuit of the display device according to the first embodiment;

FIG. 5 is a diagram illustrating waveforms of frequency-divided clock signals of the display device according to the first embodiment;

FIG. 6 is a diagram illustrating a module configuration of the display device according to the first embodiment;

FIG. 7 is a diagram illustrating a circuit configuration of a memory selection circuit and a memory selection control circuit of the display device according to the first embodiment;

FIG. 8 is a diagram illustrating an example of a table stored in storage of the display device according to the first embodiment;

FIG. 9 is a diagram illustrating an example of another table stored in the storage of the display device according to the first embodiment;

FIG. 10 is a diagram illustrating an example of still another table stored in the storage of the display device according to the first embodiment;

FIG. 11 is a diagram illustrating a coupling relation between the memory selection circuit, a distribution circuit, and the sub-pixels of the display device according to the first embodiment;

FIG. 12 is a diagram illustrating a circuit configuration of the display device according to the first embodiment;

FIG. 13 is a diagram illustrating a circuit configuration of each of the sub-pixels of the display device according to the first embodiment;

FIG. 14 is a diagram illustrating a circuit configuration of a memory of the sub-pixel of the display device according to the first embodiment;

FIG. 15 is a diagram illustrating a circuit configuration of an inversion switch of the sub-pixel of the display device according to the first embodiment;

FIG. 16 is a diagram illustrating an overview of a layout of the sub-pixel of the display device according to the first embodiment;

FIG. 17 is a timing diagram illustrating first operation timing of the display device according to the first embodiment;

FIG. 18 is a diagram illustrating an entire image displayed in the first operation of the display device according to the first embodiment;

FIG. 19 is a timing diagram illustrating second operation timing of the display device according to the first embodiment;

FIG. 20 is a diagram illustrating the entire image displayed in the second operation of the display device according to the first embodiment;

FIG. 21 is a diagram illustrating an application example of the display device according to the first embodiment;

FIG. 22 is a diagram illustrating a coupling relation between the memory selection circuit, the distribution circuit, and the sub-pixels of a display device according to a first modification of the first embodiment;

FIG. 23 is a diagram illustrating an example of a table stored in the storage of the display device according to the first modification of the first embodiment;

FIG. 24 is a diagram illustrating an operation of the display device according to the first modification of the first embodiment;

FIG. 25 is a diagram illustrating a coupling relation between the memory selection circuit, the distribution circuit, and the sub-pixels of a display device according to a second modification of the first embodiment;

FIG. 26 is a diagram illustrating a coupling relation between the memory selection circuit, the distribution circuit, and the sub-pixels of a display device according to a third modification of the first embodiment; and

FIG. 27 is a diagram illustrating a coupling relation between the memory selection circuit, the distribution circuit, and the sub-pixels of a display device according to a fourth modification of the first embodiment.

### DETAILED DESCRIPTION

The following describes a mode (embodiment) for carrying out the present disclosure in detail with reference to the drawings. The present disclosure is not limited to the description of the embodiment given below. Components described below include those easily conceivable by those skilled in the art or those substantially identical thereto. Furthermore, the components described below can be combined as appropriate. The disclosure is merely an example, and the present disclosure naturally encompasses appropriate modifications easily conceivable by those skilled in the art while maintaining the gist of the disclosure. To further clarify the description, widths, thicknesses, shapes, and the like of various parts will be schematically illustrated in the drawings as compared with actual aspects thereof, in some cases. However, they are merely examples, and interpretation of the present disclosure is not limited thereto. The same element as that illustrated in a drawing that has already been discussed is denoted by the same reference numeral through the description and the drawings, and detailed description thereof will not be repeated in some cases where appropriate.

In this disclosure, when an element is described as being “on” another element, the element can be directly on the other element, or there can be one or more elements between the element and the other element.

### First Embodiment

### Overall Configuration

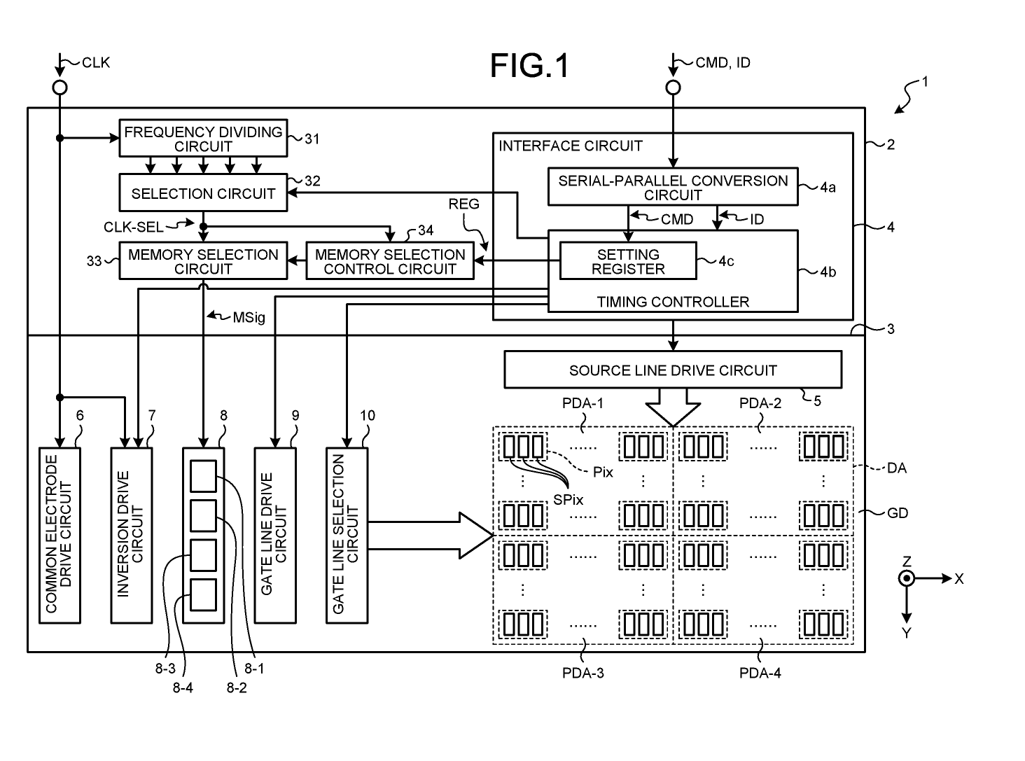

FIG. 1 is a diagram illustrating an overview of an overall configuration of a display device according to a first embodiment of the present disclosure. A display device 1 includes a first panel 2 and a second panel 3 disposed so as to be opposed to the first panel 2. The display device 1 has a display area DA in which an image is displayed and a frame area GD outside the display area DA. In the display area DA, a liquid crystal layer is sealed between the first panel 2 and the second panel 3. The display area DA includes a first partial display area PDA-1, a second partial display area PDA-2, a third partial display area PDA-3, and a fourth partial display area PDA-4.

In the first embodiment, the display device 1 is a liquid crystal display device using the liquid crystal layer. However, the present disclosure is not limited thereto. The display device 1 may be an organic electroluminescent (EL) display device using organic EL elements instead of the liquid crystal layer.

In this specification, an X-direction denotes a direction parallel to principal surfaces of the first panel 2 and the second panel 3, and a Y-direction denotes a direction parallel to the principal surfaces and intersecting the X-direction. A Z-direction denotes a direction orthogonal to the principal surfaces.

The second partial display area PDA-2 is adjacent to the first partial display area PDA-1 in the X-direction. The third partial display area PDA-3 is adjacent to the first partial display area PDA-1 in the Y-direction. The fourth partial display area PDA-4 is adjacent to the second partial display area PDA-2 in the Y-direction and is adjacent to the third partial display area PDA-3 in the X-direction.

In each of the first to fourth partial display areas PDA-1 to PDA-4, a plurality of pixels Pix are arranged in a matrix of N columns (where N is a natural number) arranged in the X-direction and M rows (where M is a natural number) arranged in the Y-direction. Accordingly, the pixels Pix are arranged in a matrix of (N×2) columns arranged in the X-direction and (M×2) rows arranged in the Y-direction in the display area DA.

In the first embodiment, the first to fourth partial display areas PDA-1 to PDA-4 include the same number of the pixels Pix, but this is not a limitation, i.e., the first to fourth partial display areas PDA-1 to PDA-4 may include different numbers of the pixels Pix. In the first embodiment, the display area DA includes four partial display areas PDA, but is not limited thereto. The display area DA may include three or less, or five or more partial display areas PDA.

In the first embodiment, an image displayed in the first partial display area PDA-1 is called a “first partial image”. An image displayed in the second partial display area PDA-2 is called a “second partial image”. An image displayed in the third partial display area PDA-3 is called a “third partial image”. An image displayed in the fourth partial display area PDA-4 is called a “fourth partial image”. An image displayed in the display area DA is called an “entire image”. Thus, the entire image is a combination of the first to fourth partial images.

An interface circuit 4, a source line drive circuit 5, a common electrode drive circuit 6, an inversion drive circuit 7, a memory selection signal distribution circuit 8, a gate line drive circuit 9, a gate line selection circuit 10, a frequency dividing circuit 31, a selection circuit 32, a memory selection circuit 33, and a memory selection control circuit 34 are disposed in the frame area GD.

The memory selection signal distribution circuit 8 includes a first distribution circuit 8-1, a second distribution circuit 8-2, a third distribution circuit 8-3, and a fourth distribution circuit 8-4.

A configuration can be employed in which, of these circuits, the interface circuit 4, the source line drive circuit 5, the common electrode drive circuit 6, the inversion drive circuit 7, the memory selection signal distribution circuit 8, the frequency dividing circuit 31, the selection circuit 32, the memory selection circuit 33, and the memory selection control circuit 34 are built into an integrated circuit (IC) chip, and the gate line drive circuit 9 and the gate line selection circuit 10 are provided on the first panel 2. Alternatively, a configuration can be employed in which the group of the circuits built into the IC chip is provided in a processor outside the display device 1, and the circuits are coupled to the display device 1.

Each of the pixels Pix includes a plurality of sub-pixels SPix. In the first embodiment, the sub-pixels SPix are three sub-pixels of red (R), green (G), and blue (B). However, the present disclosure is not limited thereto. The sub-pixels SPix may be four sub-pixels including a sub-pixel of white (W) in addition to the sub-pixels of red (R), green (G), and blue (B). Alternatively, the sub-pixels SPix may be five or more sub-pixels of different colors.

In the first embodiment, since each of the pixels Pix includes the three sub-pixels SPix, (M×2)×(N×2)×3 sub-pixels SPix are arranged in the display area DA. In the first embodiment, three sub-pixels SPix in each of the (M×2)×(N×2) pixels Pix are arranged in the X-direction. Thus, (N×2)×3 sub-pixels SPix are arranged in one row of the (M×2)×(N×2) pixels Pix.

Each of the sub-pixels SPix includes a plurality of memories. In the first embodiment, the memories are three memories of a first memory to a third memory. However, the present disclosure is not limited thereto. The memories may be two memories, or may be four or more memories.

In the first embodiment, since each of the sub-pixels SPix includes the three memories, (M×2)×(N×2)×3×3 memories are arranged in the display area DA. In the first embodiment, each of the sub-pixels SPix includes three memories. Thus, (N×2)×3×3 memories are arranged in one row of the (M×2)×(N×2) pixels Pix.

Each of the sub-pixels SPix performs display of the sub-pixel SPix based on sub-pixel data stored in a selected one of the first to third memories included in the sub-pixel SPix. This means that the set of (M×2)×(N×2)×3×3 memories included in the (M×2)×(N×2)×3 sub-pixels SPix is equivalent to three frame memories.

In the first embodiment, a partial image displayed based on the sub-pixel data stored in the first memory of each of the sub-pixels SPix in the first partial display area PDA-1 is called a “1ₐth partial image”. A partial image displayed based on the sub-pixel data stored in the second memory of each of the sub-pixels SPix in the first partial display area PDA-1 is called a “1_{b}th partial image”. A partial image displayed based on the sub-pixel data stored in the third memory of each of the sub-pixels SPix in the first partial display area PDA-1 is called a “1_{c}th partial image”.

A partial image displayed based on the sub-pixel data stored in the first memory of each of the sub-pixels SPix in the second partial display area PDA-2 is called a “2ₐth partial image”. A partial image displayed based on the sub-pixel data stored in the second memory of each of the sub-pixels SPix in the second partial display area PDA-2 is called a “2_{b}th partial image”. A partial image displayed based on the sub-pixel data stored in the third memory of each of the sub-pixels SPix in the second partial display area PDA-2 is called a “2_{c}th partial image”.

A partial image displayed based on the sub-pixel data stored in the first memory of each of the sub-pixels SPix in the third partial display area PDA-3 is called a “3ₐth partial image”. A partial image displayed based on the sub-pixel data stored in the second memory of each of the sub-pixels SPix in the third partial display area PDA-3 is called a “3_{b}th partial image”. A partial image displayed based on the sub-pixel data stored in the third memory of each of the sub-pixels SPix in the third partial display area PDA-3 is called a “3_{c}th partial image”.

A partial image displayed based on the sub-pixel data stored in the first memory of each of the sub-pixels SPix in the fourth partial display area PDA-4 is called a “4ₐth partial image”. A partial image displayed based on the sub-pixel data stored in the second memory of each of the sub-pixels SPix in the fourth partial display area PDA-4 is called a “4_{b}th partial image”. A partial image displayed based on the sub-pixel data stored in the third memory of each of the sub-pixels SPix in the fourth partial display area PDA-4 is called a “4_{c}th partial image”.

The interface circuit 4 includes a serial-parallel conversion circuit 4a and a timing controller 4b. The timing controller 4b includes a setting register 4c. The serial-parallel conversion circuit 4a is supplied with command data CMD and image data ID as serial data from an external circuit. Examples of the external circuit include a host central processing unit (CPU) and an application processor, but the present disclosure is not limited thereto.

The serial-parallel conversion circuit 4a converts the supplied command data CMD into parallel data, and outputs the parallel data to the setting register 4c. Values for controlling the source line drive circuit 5, the inversion drive circuit 7, the gate line drive circuit 9, the gate line selection circuit 10, the selection circuit 32, and the memory selection control circuit 34 are set in the setting register 4c based on the command data CMD.

The serial-parallel conversion circuit 4a converts the supplied image data ID into parallel data, and outputs the parallel data to the timing controller 4b. The timing controller 4b outputs the image data ID to the source line drive circuit 5 based on the values set in the setting register 4c. The timing controller 4b also controls the inversion drive circuit 7, the gate line drive circuit 9, the gate line selection circuit 10, the selection circuit 32, and the memory selection control circuit 34 based on the values set in the setting register 4c.

The common electrode drive circuit 6, the inversion drive circuit 7, and the frequency dividing circuit 31 are supplied with a reference clock signal CLK from an external circuit. Examples of the external circuit include a clock generator, but the present disclosure is not limited thereto.

The frequency dividing circuit 31 outputs a plurality of clock signals having different frequencies to the selection circuit 32 based on the reference clock signal CLK. In detail, the frequency dividing circuit 31 outputs a plurality of frequency-divided clock signals obtained by dividing the frequency of the reference clock signal CLK at a plurality of frequency dividing ratios to the selection circuit 32.

The selection circuit 32 selects one of the frequency-divided clock signals as a selected clock signal CLK-SEL under the control of the timing controller 4b. The selection circuit 32 outputs the selected clock signal CLK-SEL to the memory selection circuit 33 and the memory selection control circuit 34.

The memory selection control circuit 34 controls the memory selection circuit 33 based on a value REG related to the memory selection set in the setting register 4c. The memory selection circuit 33 outputs a memory selection signal MSig to each of the first to fourth distribution circuits 8-1 to 8-4 in synchronization with the selected clock signal CLK-SEL under the control of the memory selection control circuit 34.

The first to fourth distribution circuits 8-1 to 8-4 output the memory selection signal MSig supplied from the memory selection circuit 33, to each of the sub-pixels SPix in the first to fourth partial display areas PDA-1 to PDA-4, respectively.

In the first embodiment, the display device 1 employs a common inversion driving method. Since the display device 1 employs the common inversion driving method, the common electrode drive circuit 6 inverts the potential (common potential) of a common electrode in synchronization with the reference clock signal CLK. More specifically, the common electrode drive circuit 6 switches the potential of the common electrode, for example, between 0 V and 3 V at a predetermined period in synchronization with the reference clock signal CLK. In this manner, the potential of the common electrode can be said to be a kind of an alternating-current drive. The inversion drive circuit 7 inverts the potential of a sub-pixel electrode in synchronization with the reference clock signal CLK under the control of the timing controller 4b. More specifically, the inversion drive circuit 7 switches the potential of the sub-pixel electrode, for example, between 0 V and 3 V at the predetermined period in synchronization with the reference clock signal CLK. In this manner, the potential supplied from the inversion drive circuit 7 to each of the sub-pixels can be said to be a kind of the alternating-current drive. The common electrode drive circuit 6 and the inversion drive circuit 7 supply these potentials varying at the predetermined period to each of the sub-pixels, and thus, the display device 1 can carry out the common inversion driving method. In the first embodiment, the display device 1 is what is called a normally black liquid crystal display device that displays a black color when no voltage is applied to a liquid crystal and displays a white color when a voltage is applied to the liquid crystal. The normally black liquid crystal display device displays the black color when the potential of the sub-pixel electrode is in phase with the common potential, and displays the white color when the potential of the sub-pixel electrode is out of phase with the common potential.

To display the image on the display device 1, the sub-pixel data needs to be stored in each of the first to third memories of each of the sub-pixels SPix. To store the sub-pixel data in each of the memories, the gate line drive circuit 9 outputs a gate signal for selecting one row of the (M×2)×(N×2) pixels Pix in the display area DA under the control of the timing controller 4b.

in a MIP display device with each of the sub-pixels having one memory, one gate line is disposed for each row (pixel row (sub-pixel row)). In the present embodiment, however, each of the sub-pixels SPix includes the three memories of the first to third memories. Thus, in the present embodiment, three gate lines are arranged for each of the rows. The three gate lines are electrically coupled to the first to third memories of each of the sub-pixels SPix included in a corresponding one of the rows.

If the sub-pixels SPix are operated by the gate signal and an inverted gate signal inverted from the gate signal, six gate lines are arranged for each of the rows.

The three or six gate lines arranged for each of the rows correspond to a gate line group of the present disclosure. In the first embodiment, since the display device 1 includes the (M×2) rows of the pixels Pix, (M×2) gate line groups are arranged.

The gate line drive circuit 9 includes (M×2) output terminals corresponding to the (M×2) rows of the pixels Pix. Under the control of the timing controller 4b, the gate line drive circuit 9 sequentially outputs the gate signal for selecting each of the (M×2) rows, from its respective one of the (M×2) output terminals.

Under the control of the timing controller 4b, the gate line selection circuit 10 selects one of the three gate lines arranged in one row. This selection causes the gate signal output from the gate line drive circuit 9 to be supplied to the selected one of the three gate lines arranged in one row.

Under the control of the timing controller 4b, the source line drive circuit 5 outputs the sub-pixel data to each of the memories selected by the gate signal. With this process, the sub-pixel data is sequentially stored in the first to third memories of each of the sub-pixels SPix in one row.

The display device 1 performs line-sequentially scanning on the (M×2) rows of the pixels Pix to store the sub-pixel data of one frame data in the first memory of each of the sub-pixels SPix. The display device 1 performs the line-sequential scanning three times to store three pieces of frame data in the first to third memories of each of the sub-pixels SPix.

In this operation, the display device 1 can employ a procedure of writing to the first memory, writing to the second memory, and writing to the third memory for each scanning operation of one row. By performing the scanning operation on the first row to the (M×2)th row, the display device 1 can store the sub-pixel data in the first to third memories of each of the sub-pixels SPix in one line-sequential scanning operation.

In the first embodiment, three memory selection lines are arranged for each row in each of the first to fourth partial display areas PDA-1 to PDA-4. Thus, (M×3×4) memory selection lines are arranged in the display area DA.

If the sub-pixels SPix are operated by the memory selection signal MSig and an inverted memory selection signal xMSig inverted from the memory selection signal MSig, six memory selection lines are arranged for each row in each of the first to fourth partial display areas PDA-1 to PDA-4.

The three or six memory selection lines arranged for each row in each of the first to fourth partial display areas PDA-1 to PDA-4 correspond to a memory selection line group of the present disclosure. In the first embodiment, each of the first to fourth partial display areas PDA-1 to PDA-4 includes M rows of the pixels Pix. Thus, M memory selection line groups are arranged in each of the first to fourth partial display areas PDA-1 to PDA-4. Thus, (M×4) memory selection line groups are arranged in the display area DA.

One end of each of the three memory selection lines of each row in the first partial display area PDA-1 is coupled to the first distribution circuit 8-1. One end of each of the three memory selection lines of each row in the second partial display area PDA-2 is coupled to the second distribution circuit 8-2. One end of each of the three memory selection lines of each row in the third partial display area PDA-3 is coupled to the third distribution circuit 8-3. One end of each of the three memory selection lines of each row in the fourth partial display area PDA-4 is coupled to the fourth distribution circuit 8-4. The three memory selection lines of each row in the first partial display area PDA-1 are electrically coupled to the first to third memories of each of the (N×3) sub-pixels SPix included in the row in the first partial display area PDA-1, respectively. The three memory selection lines of each row in the second partial display area PDA-2 are electrically coupled to the first to third memories of each of the (N×3) sub-pixels SPix included in the row in the second partial display area PDA-2, respectively. The three memory selection lines of each row in the third partial display area PDA-3 are electrically coupled to the first to third memories of each of the (N×3) sub-pixels SPix included in the row in the third partial display area PDA-3, respectively. The three memory selection lines of each row in the fourth partial display area PDA-4 are electrically coupled to the first to third memories of each of the (N×3) sub-pixels SPix included in the row in the fourth partial display area PDA-4, respectively.

The memory selection circuit 33 handles each of the first to fourth partial display areas PDA-1 to PDA-4 as an individual unit, which is referred to hereafter as a “selection unit”. The memory selection circuit 33 simultaneously selects, in one selection unit at a time, one of the first to third memories in each of the sub-pixels SPix in that selection unit.

In detail, the memory selection circuit 33 simultaneously selects the first memory of each of the sub-pixels SPix in the first partial display area PDA-1. Otherwise, the memory selection circuit 33 simultaneously selects the second memory of each of the sub-pixels SPix in the first partial display area PDA-1. Still otherwise, the memory selection circuit 33 simultaneously selects the third memory of each of the sub-pixels SPix in the first partial display area PDA-1. Accordingly, the display device 1 can display one of the three first partial images in the first partial display area PDA-1 by switching which of the first to third memories of each of the sub-pixels SPix in the first partial display area PDA-1 is selected. With this process, the display device 1 can change the first partial image at once in the first partial display area PDA-1, and it can thus change the first partial image in a short period of time.

The memory selection circuit 33, in the same manner as in the first partial display area PDA-1, also switches which of the first to third memories of each of the sub-pixels SPix in the second to fourth partial display areas PDA-2 to PDA-4 is selected.

With this process, the display device 1 can change the entire image in a short period of time. The display device 1 can also perform animation display (moving image display) by sequentially switching which of the first to third memories of each of the sub-pixels SPix is selected.

### Sectional Structure

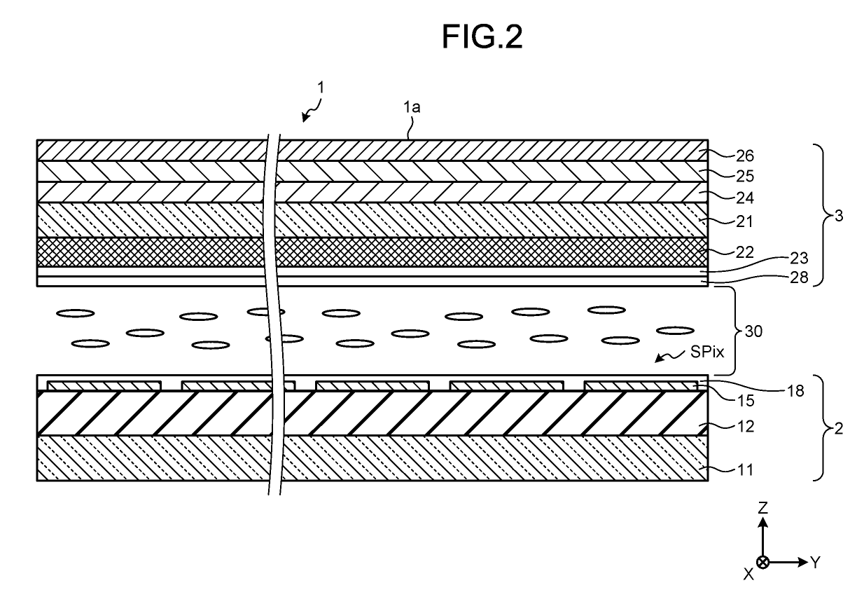

FIG. 2 is a sectional view of the display device according to the first embodiment. As illustrated in FIG. 2, the display device 1 includes the first panel 2, the second panel 3, and a liquid crystal layer 30. The second panel 3 is disposed so as to be opposed to the first panel 2. The liquid crystal layer 30 is provided between the first panel 2 and the second panel 3. A surface that is one principal surface of the second panel 3 serves as a display surface 1a for displaying the image.

Light incident from an exterior on the display surface 1a side is reflected by a reflective electrode 15 of the first panel 2 and transmitted from the display surface 1a. The display device 1 is a reflective liquid crystal display device that uses this reflected light to display the image on the display surface 1a. A direction parallel to the display surface 1a corresponds to the X-direction. A direction intersecting the X-direction in a plane parallel to the display surface 1a corresponds to the Y-direction. A direction orthogonal to the display surface 1a corresponds to the Z-direction.

The first panel 2 includes a first substrate 11, an insulating layer 12, the reflective electrode 15, and an orientation film 18. Examples of the first substrate 11 include a glass substrate and a resin substrate. A surface of the first substrate 11 is provided with circuit elements and various types of wiring, such as the gate lines and data lines, which are not illustrated. The circuit elements include switching elements, such as thin-film transistors (TFTs), and capacitive elements.

The insulating layer 12 is provided on the first substrate 11, and planarizes surfaces of, for example, the circuit elements and the various types of wiring as a whole. A plurality of reflective electrodes 15 are provided on the insulating layer 12. The orientation film 18 is provided between the reflective electrodes 15 and the liquid crystal layer 30. The reflective electrodes 15 are provided in rectangular shapes, one for each of the sub-pixels SPix. The reflective electrodes 15 are made of a metal, such as aluminum (Al) or silver (Ag). The reflective electrodes 15 may have a configuration laminated with these metal materials and a light-transmitting conductive material, such as indium tin oxide (ITO). The reflective electrodes 15 are made using a material having good reflectance, and serve as reflective plates that diffusely reflect the light incident from the exterior.

The light reflected by the reflective electrode 15 is scattered by the diffuse reflection, but travels in a uniform direction toward the display surface 1a. A change in level of a voltage applied to the reflective electrode 15 changes the transmission state of the light in the liquid crystal layer 30 on the upper side of the reflective electrodes, that is, the transmission state of the light of each of the sub-pixels. In other words, the reflective electrode 15 also has a function as the sub-pixel electrode.

The second panel 3 includes a second substrate 21, a color filter 22, a common electrode 23, an orientation film 28, a ¼ wavelength plate 24, a ½ wavelength plate 25, and a polarizing plate 26. One of both surfaces of the second substrate 21 opposed to the first panel 2 is provided with the color filter 22 and the common electrode 23 in this order. The orientation film 28 is provided between the common electrode 23 and the liquid crystal layer 30. A surface on the display surface 1a side of the second substrate 21 is provided with the ¼ wavelength plate 24, the ½ wavelength plate 25, and the polarizing plate 26 in this order.

Examples of the second substrate 21 include a glass substrate and a resin substrate. The common electrode 23 is made of a light-transmitting conductive material, such as ITO. The common electrode 23 is disposed so as to be opposed to the reflective electrodes 15, and supplies a common potential to each of the sub-pixels SPix. The color filter 22 includes filters having, for example, three colors of red (R), green (G), and blue (B), but the present disclosure is not limited to this example.

The liquid crystal layer 30 includes, for example, nematic liquid crystals. A change in level of a voltage between the common electrode 23 and the reflective electrode 15 changes the orientation state of liquid crystal molecules in the liquid crystal layer 30. With this process, the light passing through the liquid crystal layer 30 is modulated on a per sub-pixel SPix basis.

For example, external light serves as the incident light incident from the display surface 1a side of the display device 1, and reaches the reflective electrodes 15 through the second panel 3 and the liquid crystal layer 30. The incident light is reflected on the reflective electrodes 15 of the sub-pixels SPix. The reflected light is modulated on a per sub-pixel SPix basis, and transmitted from the display surface 1a. With this process, the image is displayed.

### Circuit Configuration

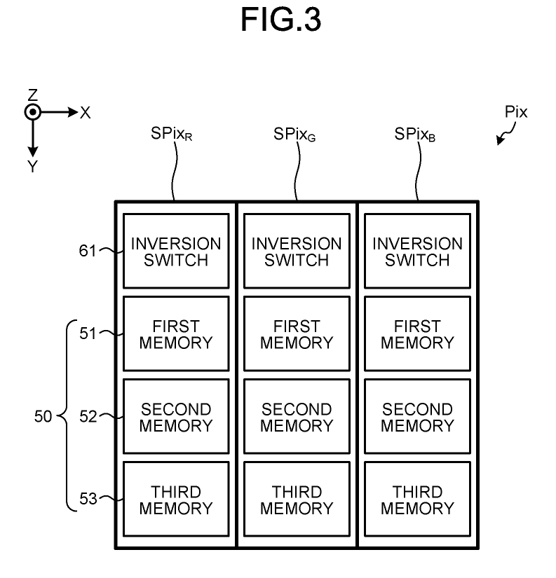

FIG. 3 is a diagram illustrating an arrangement of the sub-pixels in each of the pixels of the display device according to the first embodiment. Each of the pixels Pix includes a red (R) sub-pixel SPix_{R}, a green (R) sub-pixel SPix_{G}, and a blue (B) sub-pixel SPix_{E}. The sub-pixels SPix_{R}, SPix_{G}, and SPix_{E} are arranged in the X-direction.

Each of the sub-pixels SPix_{R}, SPix_{G}, and SPix_{E} includes a memory block 50 and an inversion switch 61. The memory block 50 includes a first memory 51, a second memory 52, and a third memory 53. The inversion switch 61, the first memory 51, the second memory 52, and the third memory 53 are arranged in the Y-direction.

Each of the first, second, and third memories 51, 52, and 53 is a memory cell that stores one-bit data. However, the present disclosure is not limited thereto. Each of the first, second, and third memories 51, 52, and 53 may be a memory cell that stores therein data of two or more bits.

The inversion switch 61 is electrically coupled between the first, second, and third memories 51, 52, and 53 and the sub-pixel electrode (reflective electrode) 15 (refer to FIG. 2). The inversion switch 61 outputs, to the sub-pixel electrode 15, a signal corresponding to a signal obtained by logically inverting the sub-pixel data output at intervals of a constant period from one memory selected from the first, second, and third memories 51, 52, and 53. In detail, the inversion switch 61 outputs, to the sub-pixel electrode 15, a display signal (inverted in synchronization with the reference clock signal CLK) supplied from the inversion drive circuit 7 based on the sub-pixel data output from the selected memory. The period of the inversion of the display signal is the same as the period of the inversion of the potential (common potential) of the common electrode 23.

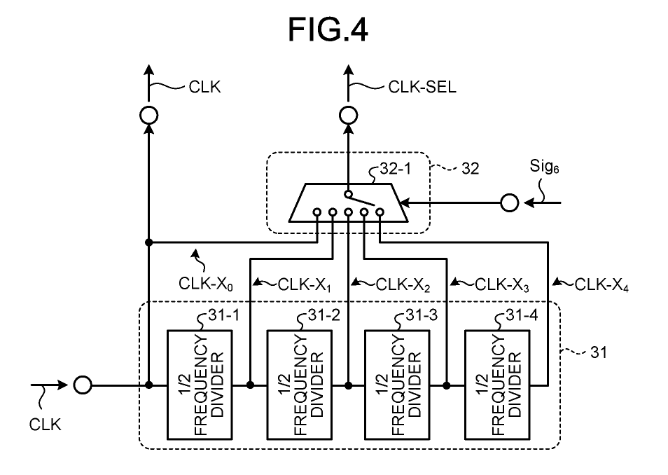

FIG. 4 is a diagram illustrating a circuit configuration of the frequency dividing circuit and the selection circuit of the display device according to the first embodiment.

The frequency dividing circuit 31 includes a first ½ frequency divider 31-1 to a fourth ½ frequency divider 31-4 coupled in a daisy chain configuration. Each of the first ½ frequency divider 31-1 to the fourth ½ frequency divider 31-4 can have a flip-flop configuration.

The first ½ frequency divider 31-1 is supplied with a first frequency-divided clock signal CLK-X₀ that is the reference clock signal CLK. The first frequency-divided clock signal CLK-X₀ can be considered to be a signal obtained by dividing the frequency of the reference clock signal CLK into a 1/1 frequency thereof.

The first ½ frequency divider 31-1 outputs a second frequency-divided clock signal CLK-X₁ obtained by dividing the frequency of the first frequency-divided clock signal CLK-X₀ in half to the second ½ frequency divider 31-2 and the selection circuit 32. The second ½ frequency divider 31-2 outputs a third frequency-divided clock signal CLK-X₂ obtained by dividing the frequency of the second frequency-divided clock signal CLK-X₁ in half to the third ½ frequency divider 31-3 and the selection circuit 32.

The third ½ frequency divider 31-3 outputs a fourth frequency-divided clock signal CLK-X₃ obtained by dividing the frequency of the third frequency-divided clock signal CLK-X₂ in half to the fourth ½ frequency divider 31-4 and the selection circuit 32. The fourth ½ frequency divider 31-4 outputs a fifth frequency-divided clock signal CLK-X₄ obtained by dividing the frequency of the fourth frequency-divided clock signal CLK-X₃ in half to the selection circuit 32.

The selection circuit 32 includes a selector 32-1. The selector 32-1 is supplied with the first to fifth frequency-divided clock signals CLK-X₀ to CLK-X₄. The selector 32-1 selects one frequency-divided clock signal of the first to fifth frequency-divided clock signals CLK-X₀ to CLK-X₄ as the selected clock signal CLK-SEL based on a control signal Sig₆ supplied from the timing controller 4b. The selector 32-1 outputs the selected clock signal CLK-SEL to the memory selection circuit 33 and the memory selection control circuit 34.

In the first embodiment, the frequency dividing circuit 31 includes the first to fourth ½ frequency dividers 31-1 to 31-4. However, the present disclosure is not limited thereto. The frequency dividing circuit 31 may include ⅓ frequency dividers or ¼ frequency dividers. In the first embodiment, the frequency dividing circuit 31 includes the four ½ frequency dividers. However, the present disclosure is not limited thereto. The frequency dividing circuit 31 may include three or less, or five or more frequency dividers, and may output three or less, or five or more frequency-divided clock signals to the selection circuit 32. In the first embodiment, the frequency dividing circuit 31 includes the first to fourth ½ frequency dividers 31-1 to 31-4 coupled in a daisy chain configuration. However, the present disclosure is not limited thereto. The frequency-divided clock signals can be generated by various circuit configurations.

In the first embodiment, the display device 1 includes the frequency dividing circuit 31 as a clock signal output circuit. However, the present disclosure is not limited thereto. The display device 1 may include, instead of the frequency dividing circuit 31, a multiplier circuit as the clock signal output circuit, which outputs a plurality of multiplied clock signals obtained by multiplying the frequency of the reference clock signal CLK by a plurality of multiplication factors.

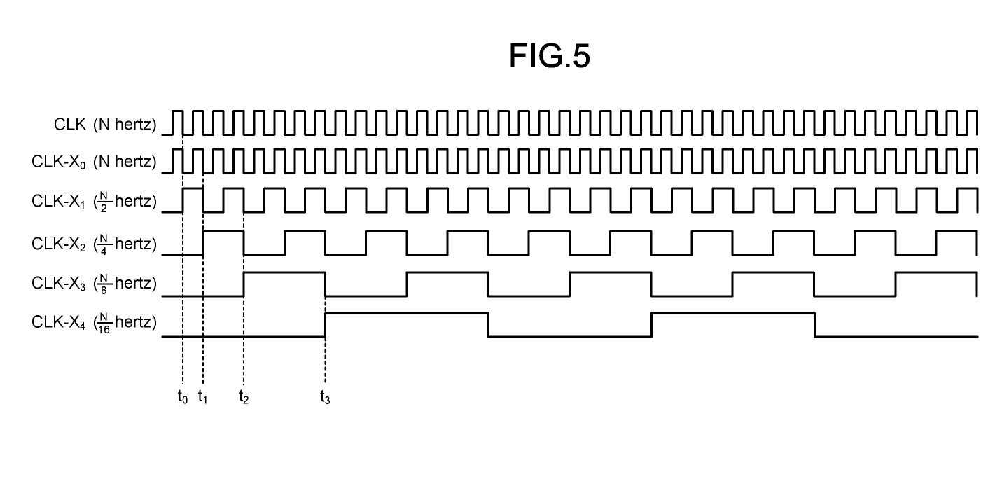

FIG. 5 is a diagram illustrating waveforms of the frequency-divided clock signals of the display device according to the first embodiment.

The frequency of the reference clock signal CLK is assumed to be N hertz (where N is a positive number). The frequency of the first frequency-divided clock signal CLK-X₀ is N hertz, which is the same as the frequency of the reference clock signal CLK.

The first ½ frequency divider 31-1 outputs the second frequency-divided clock signal CLK-X₁ obtained by dividing the frequency of the first frequency-divided clock signal CLK-X₀ in half. The frequency of the second frequency-divided clock signal CLK-X₁ is N/2 hertz, which is ½ times the frequency of the first frequency-divided clock signal CLK-X₀. The second frequency-divided clock signal CLK-X₁ rises at time t₀ that is the time of a falling edge of the first frequency-divided clock signal CLK-X₀. Although, in the first embodiment, the second frequency-divided clock signal CLK-X₁ rises at the falling edge of the first frequency-divided clock signal CLK-X₀, the present disclosure is not limited thereto. The second frequency-divided clock signal CLK-X₁ may rise at a rising edge of the first frequency-divided clock signal CLK-X₀. The third frequency-divided clock signal CLK-X₂, the fourth frequency-divided clock signal CLK-X₃, and the fifth frequency-divided clock signal CLK-X₄ described below all function the same as the second frequency-divided clock signal CLK-X₁.

The second ½ frequency divider 31-2 outputs the third frequency-divided clock signal CLK-X₂ obtained by dividing the frequency of the second frequency-divided clock signal CLK-X₁ in half. The frequency of the third frequency-divided clock signal CLK-X₂ is N/4 hertz, which is ½ times the frequency of the second frequency-divided clock signal CLK-X₁. The third frequency-divided clock signal CLK-X₂ rises at time t₁ that is the time of a falling edge of the second frequency-divided clock signal CLK-X₁.

The third ½ frequency divider 31-3 outputs the fourth frequency-divided clock signal CLK-X₃ obtained by dividing the frequency of the third frequency-divided clock signal CLK-X₂ in half. The frequency of the fourth frequency-divided clock signal CLK-X₃ is N/8 hertz, which is ½ times the frequency of the third frequency-divided clock signal CLK-X₂. The fourth frequency-divided clock signal CLK-X₃ rises at time t₂ that is the time of a falling edge of the third frequency-divided clock signal CLK-X₂.

The fourth ½ frequency divider 31-4 outputs the fifth frequency-divided clock signal CLK-X₄ obtained by dividing the frequency of the fourth frequency-divided clock signal CLK-X₃ in half. The frequency of the fifth frequency-divided clock signal CLK-X₄ is N/16 hertz, which is ½ times the frequency of the fourth frequency-divided clock signal CLK-X₃. The fifth frequency-divided clock signal CLK-X₄ rises at time t₃ that is the time of a falling edge of the fourth frequency-divided clock signal CLK-X₃.

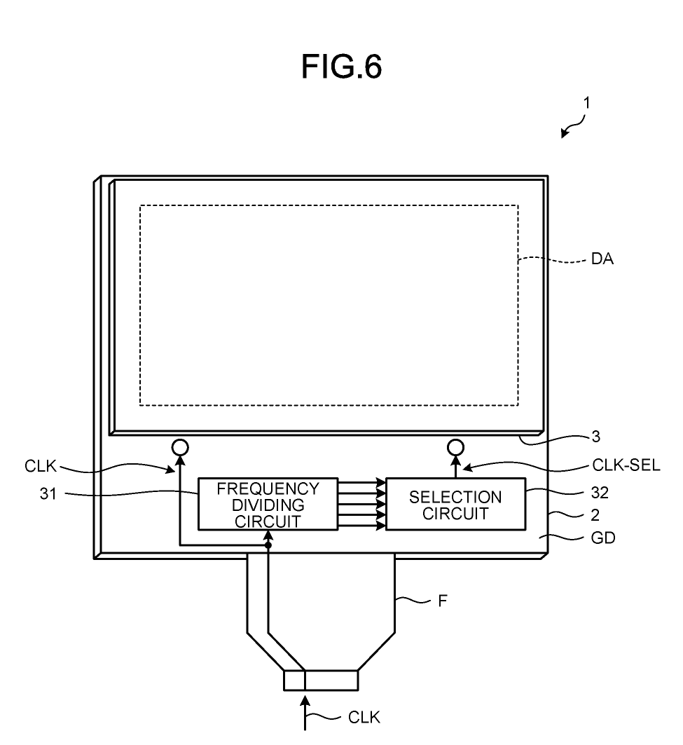

FIG. 6 is a diagram illustrating a module configuration of the display device according to the first embodiment. In detail, FIG. 6 is a diagram illustrating an arrangement of the frequency dividing circuit 31 and the selection circuit 32 in the display device 1. The frequency dividing circuit 31 and the selection circuit 32 are disposed at a portion in the frame area GD where the first panel 2 does not overlap the second panel 3. A flexible substrate F is mounted on the first panel 2. The reference clock signal CLK is supplied to the frequency dividing circuit 31 through the flexible substrate F. The reference clock signal CLK is also supplied to the common electrode drive circuit 6 (refer to FIG. 1) and the inversion drive circuit 7 (refer to FIG. 1).

The frequency dividing circuit 31 outputs the first to fifth frequency-divided clock signals CLK-X₀ to CLK-X₄ obtained by dividing the frequency of the reference clock signal CLK to the selection circuit 32. The selection circuit 32 selects one of the first to fifth frequency-divided clock signals CLK-X₀ to CLK-X₄ as the selected clock signal CLK-SEL. The selection circuit 32 outputs the selected clock signal CLK-SEL to the memory selection circuit 33 and the memory selection control circuit 34 (refer to FIG. 1).

The frequency dividing circuit 31 and the selection circuit 32 may be mounted on the first panel 2 as a chip-on-glass (COG) module. The frequency dividing circuit 31 and the selection circuit 32 may alternatively be mounted on the flexible substrate F as the chip-on-glass (COG) module.

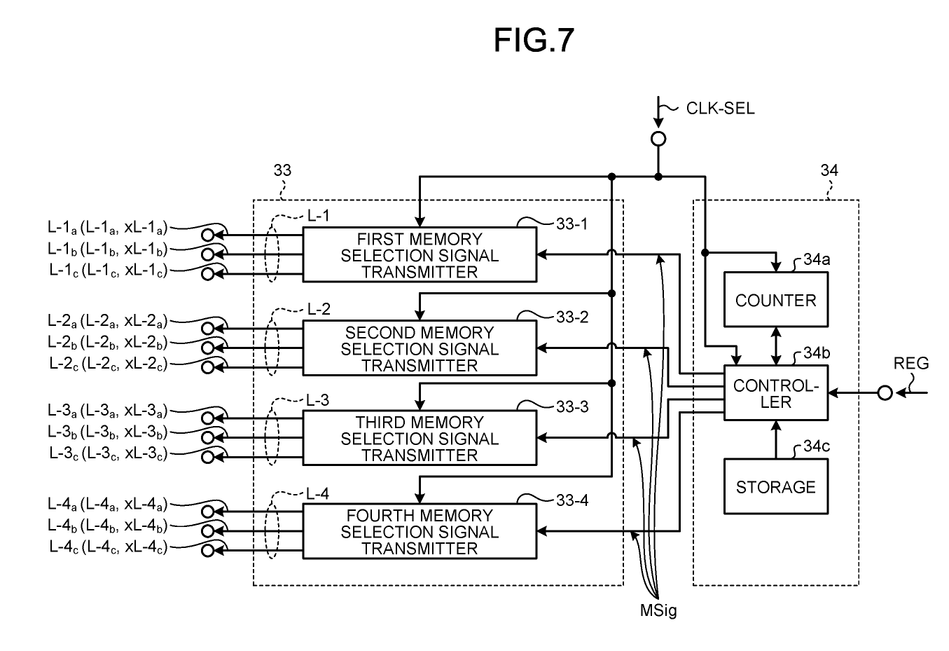

FIG. 7 is a diagram illustrating a circuit configuration of the memory selection circuit and the memory selection control circuit of the display device according to the first embodiment.

The memory selection circuit 33 includes a first memory selection signal transmitter 33-1, a second memory selection signal transmitter 33-2, a third memory selection signal transmitter 33-3, and a fourth memory selection signal transmitter 33-4. The memory selection control circuit 34 includes a counter 34a, a controller 34b, and storage 34c.

The first memory selection signal transmitter 33-1, the second memory selection signal transmitter 33-2, the third memory selection signal transmitter 33-3, the fourth memory selection signal transmitter 33-4, the counter 34a, and the controller 34b operate in synchronization with the selected clock signal CLK-SEL.

In the first embodiment, the counter 34a is a three-bit counter capable of counting from 0 to 7, but is not limited thereto. The counter 34a may be a two-bit counter or a four or more-bit counter.

The first memory selection signal transmitter 33-1 is coupled to the first distribution circuit 8-1 (FIG. 1) through a first memory selection signal supply line group L-1. The first memory selection signal supply line group L-1 includes a 1ₐth memory selection signal supply line L-1ₐ, a 1_{b}th memory selection signal supply line L-1_{b}, and a 1ₐth memory selection signal supply line L-1ₐ. If the sub-pixels SPix are operated by the memory selection signal MSig and the inverted memory selection signal xMSig inverted from the memory selection signal MSig, the first memory selection signal supply line group L-1 further includes a 1ₐth inverted memory selection signal supply line xL-1ₐ, a 1_{b}th inverted memory selection signal supply line xL-1_{b}, and a 1ₐth inverted memory selection signal supply line xL-1ₐ.

In the same manner, the second to fourth memory selection signal transmitters 33-2 to 33-4 are respectively coupled to the second to fourth distribution circuits 8-2 to 8-4 (refer to FIG. 1) through the second to fourth memory selection signal supply line groups L-2 to L-4.

The second memory selection signal supply line group L-2 includes 2ₐth to 2ₐth memory selection signal supply lines L-2, to L-2_{c}. If the sub-pixels SPix are operated by the memory selection signal MSig and the inverted memory selection signal xMSig inverted from the memory selection signal MSig, the second memory selection signal supply line group L-2 further includes 2ₐth to 2ₐth inverted memory selection signal supply lines xL-2ₐ to xL-2ₐ.

The third memory selection signal supply line group L-3 includes 3ₐth to 3_{c}th memory selection signal supply lines L-3, to L-3_{c}. If the sub-pixels SPix are operated by the memory selection signal MSig and the inverted memory selection signal xMSig inverted from the memory selection signal MSig, the third memory selection signal supply line group L-3 further includes 3ₐth to 3_{c}th inverted memory selection signal supply lines xL-3ₐ to xL-3_{c}.

The fourth memory selection signal supply line group L-4 includes 4ₐth to 4_{c}th memory selection signal supply lines L-4, to L-4_{c}. If the sub-pixels SPix are operated by the memory selection signal MSig and the inverted memory selection signal xMSig inverted from the memory selection signal MSig, the fourth memory selection signal supply line group L-4 further includes 4ₐth to 4_{c}th inverted memory selection signal supply lines xL-4ₐ to xL-4_{c}.

The timing controller 4b supplies the controller 34b with the value REG of the setting register 4c related to the memory selection. Based on the value REG, the controller 34b reads one of a plurality of tables stored in the storage 34c, and controls counting of the counter 34a. The controller 34b controls the first to fourth memory selection signal transmitters 33-1 to 33-4 based on the counter value of the counter 34a.

Under the control of the controller 34b, the first memory selection signal transmitter 33-1 outputs the memory selection signal MSig to one of the 1ₐth to 1_{c}th memory selection signal supply lines L-1, to L-1_{c}.

Under the control of the controller 34b, the second memory selection signal transmitter 33-2 outputs the memory selection signal MSig to one of the 2ₐth to 2_{c}th memory selection signal supply lines L-2, to L-2_{c}.

Under the control of the controller 34b, the third memory selection signal transmitter 33-3 outputs the memory selection signal MSig to one of the 3ₐth to 3_{c}th memory selection signal supply lines L-3, to L-3_{c}.

Under the control of the controller 34b, the fourth memory selection signal transmitter 33-4 outputs the memory selection signal MSig to one of the 4ₐth to 4_{c}th memory selection signal supply lines L-4, to L-4_{c}.

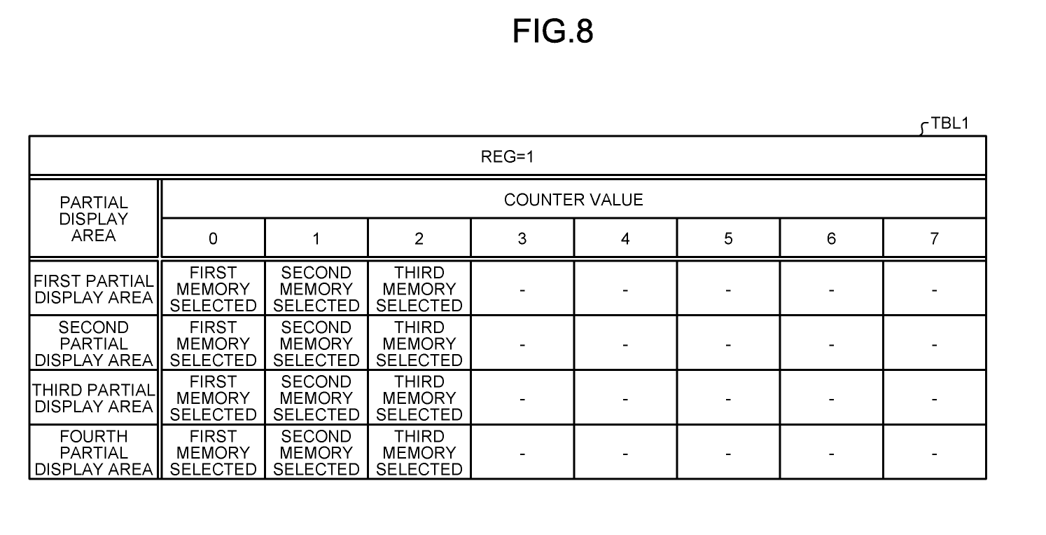

FIG. 8 is a diagram illustrating an example of a table stored in the storage of the display device according to the first embodiment.

When the value REG is 1, the controller 34b refers to a table TBL1 illustrated in FIG. 8. When the value REG is 1, the controller 34b causes the counter 34a to operate as a ternary counter. Consequently, the counter 34a counts 0, 1, 2, 0, . . . in synchronization with the selected clock signal CLK-SEL.

When the counter value is 0, the controller 34b controls the first to fourth memory selection signal transmitters 33-1 to 33-4 such that the first memory 51 of each of the sub-pixels SPix in the first to fourth partial display areas PDA-1 to PDA-4 is selected. In order to select the first memory 51 of each of the sub-pixels SPix in the first to fourth partial display areas PDA-1 to PDA-4, the first to fourth memory selection signal transmitters 33-1 to 33-4 output the memory selection signal MSig to the 1ₐth to 4ₐth memory selection signal supply lines L-1, to L-4ₐ, respectively.

With this process, the display device 1 displays the entire image that is a combination of the 1ₐth to 4ₐth partial images when the counter value is 0.

When the counter value is 1, the controller 34b controls the first to fourth memory selection signal transmitters 33-1 to 33-4 such that the second memory 52 of each of the sub-pixels SPix in the first to fourth partial display areas PDA-1 to PDA-4 is selected. In order to select the second memory 52 of each of the sub-pixels SPix in the first to fourth partial display areas PDA-1 to PDA-4, the first to fourth memory selection signal transmitters 33-1 to 33-4 output the memory selection signal MSig to the 1_{b}th to 4_{b}th memory selection signal supply lines L-1_{b} to L-4_{b}, respectively.

With this process, the display device 1 displays the entire image that is a combination of the 1_{b}th to 4_{b}th partial images when the counter value is 1.

When the counter value is 2, the controller 34b controls the first to fourth memory selection signal transmitters 33-1 to 33-4 such that the third memory 53 of each of the sub-pixels SPix in the first to fourth partial display areas PDA-1 to PDA-4 is selected. In order to select the third memory 53 of each of the sub-pixels SPix in the first to fourth partial display areas PDA-1 to PDA-4, the first to fourth memory selection signal transmitters 33-1 to 33-4 output the memory selection signal MSig to the 1_{c}th to 4_{c}th memory selection signal supply lines L-1_{c} to L-4_{c}, respectively.

With this process, the display device 1 displays the entire image that is a combination of the 1_{c}th to 4_{c}th partial images when the counter value is 2.

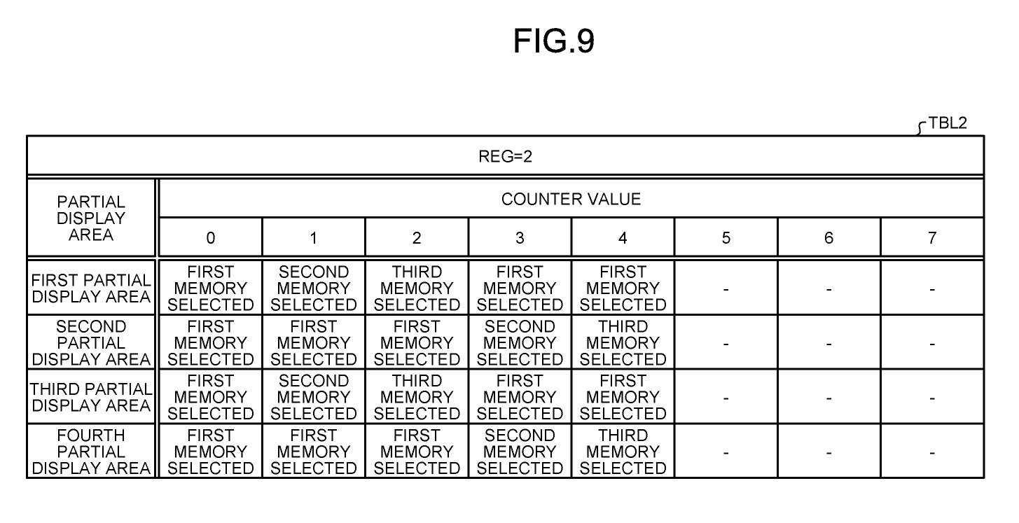

FIG. 9 is a diagram illustrating an example of another table stored in the storage of the display device according to the first embodiment.

When the value REG is 2, the controller 34b refers to a table TBL2 illustrated in FIG. 9. When the value REG is 2, the controller 34b causes the counter 34a to operate as a quinary counter. Consequently, the counter 34a counts 0, 1, 2, 3, 4, 0, . . . in synchronization with the selected clock signal CLK-SEL.

When the counter value is 0, the controller 34b controls the first to fourth memory selection signal transmitters 33-1 to 33-4 such that the first memory 51 of each of the sub-pixels SPix in the first to fourth partial display areas PDA-1 to PDA-4 is selected. In order to select the first memory 51 of each of the sub-pixels SPix in the first to fourth partial display areas PDA-1 to PDA-4, the first to fourth memory selection signal transmitters 33-1 to 33-4 output the memory selection signal MSig to the 1ₐth to 4ₐth memory selection signal supply lines L-1, to L-4ₐ, respectively.

With this process, the display device 1 displays the entire image that is a combination of the 1ₐth to 4ₐth partial images when the counter value is 0.

When the counter value is 1, the controller 34b controls the first and third memory selection signal transmitters 33-1 and 33-3 such that the second memory 52 of each of the sub-pixels SPix in the first and third partial display areas PDA-1 and PDA-3 is selected. In order to select the second memory 52 of each of the sub-pixels SPix in the first and third partial display areas PDA-1 and PDA-3, the first and third memory selection signal transmitters 33-1 and 33-3 output the memory selection signal MSig to the 1_{b}th and 3_{b}th memory selection signal supply lines L-1_{b} and L-3_{b}, respectively.

When the counter value is 1, the controller 34b controls the second and fourth memory selection signal transmitters 33-2 and 33-4 such that the first memory 51 of each of the sub-pixels SPix in the second and fourth partial display areas PDA-2 and PDA-4 is selected. In order to select the first memory 51 of each of the sub-pixels SPix in the second and fourth partial display areas PDA-2 and PDA-4, the second and fourth memory selection signal transmitters 33-2 and 33-4 output the memory selection signal MSig to the 2ₐth and 4ₐth memory selection signal supply lines L-2ₐ and L-4ₐ, respectively.

With this process, the display device 1 displays the entire image that is a combination of the 1_{b}th, 2ₐth, 3_{b}th, and 4ₐth partial images when the counter value is 1.

When the counter value is 2, the controller 34b controls the first and third memory selection signal transmitters 33-1 and 33-3 such that the third memory 53 of each of the sub-pixels SPix in the first and third partial display areas PDA-1 and PDA-3 is selected. In order to select the third memory 53 of each of the sub-pixels SPix in the first and third partial display areas PDA-1 and PDA-3, the first and third memory selection signal transmitters 33-1 and 33-3 output the memory selection signal MSig to the 1_{c}th and 3_{c}th memory selection signal supply lines L-1_{c} and L-3_{c}, respectively.

When the counter value is 2, the controller 34b controls the second and fourth memory selection signal transmitters 33-2 and 33-4 such that the first memory 51 of each of the sub-pixels SPix in the second and fourth partial display areas PDA-2 and PDA-4 is selected. In order to select the first memory 51 of each of the sub-pixels SPix in the second and fourth partial display areas PDA-2 and PDA-4, the second and fourth memory selection signal transmitters 33-2 and 33-4 output the memory selection signal MSig to the 2ₐth and 4ₐth memory selection signal supply lines L-2ₐ and L-4ₐ, respectively.

With this process, the display device 1 displays the entire image that is a combination of the 1_{c}th, 2ₐth, 3_{c}th, and 4ₐth partial images when the counter value is 2.

When the counter value is 3, the controller 34b controls the first and third memory selection signal transmitters 33-1 and 33-3 such that the first memory 51 of each of the sub-pixels SPix in the first and third partial display areas PDA-1 and PDA-3 is selected. In order to select the first memory 51 of each of the sub-pixels SPix in the first and third partial display areas PDA-1 and PDA-3, the first and third memory selection signal transmitters 33-1 and 33-3 output the memory selection signal MSig to the 1ₐth and 3ₐth memory selection signal supply lines L-1, and L-3ₐ, respectively.

When the counter value is 3, the controller 34b controls the second and fourth memory selection signal transmitters 33-2 and 33-4 such that the second memory 52 of each of the sub-pixels SPix in the second and fourth partial display areas PDA-2 and PDA-4 is selected. In order to select the second memory 52 of each of the sub-pixels SPix in the second and fourth partial display areas PDA-2 and PDA-4, the second and fourth memory selection signal transmitters 33-2 and 33-4 output the memory selection signal MSig to the 2_{b}th and 4_{b}th memory selection signal supply lines L-2_{b} and L-4_{b}, respectively.

With this process, the display device 1 displays the entire image that is a combination of the 1ₐth, 2_{b}th, 3ₐth, and 4_{b}th partial images when the counter value is 3.

When the counter value is 4, the controller 34b controls the first and third memory selection signal transmitters 33-1 and 33-3 such that the first memory 51 of each of the sub-pixels SPix in the first and third partial display areas PDA-1 and PDA-3 is selected. In order to select the first memory 51 of each of the sub-pixels SPix in the first and third partial display areas PDA-1 and PDA-3, the first and third memory selection signal transmitters 33-1 and 33-3 output the memory selection signal MSig to the 1ₐth and 3ₐth memory selection signal supply lines L-1, and L-3ₐ, respectively.

When the counter value is 4, the controller 34b controls the second and fourth memory selection signal transmitters 33-2 and 33-4 such that the third memory 53 of each of the sub-pixels SPix in the second and fourth partial display areas PDA-2 and PDA-4 is selected. In order to select the third memory 53 of each of the sub-pixels SPix in the second and fourth partial display areas PDA-2 and PDA-4, the second and fourth memory selection signal transmitters 33-2 and 33-4 output the memory selection signal MSig to the 2_{c}th and 4_{c}th memory selection signal supply lines L-2_{c} and L-4_{c}, respectively.

With this process, the display device 1 displays the entire image that is a combination of the 1ₐth, 2_{c}th, 3ₐth, and 4_{c}th partial images when the counter value is 4.

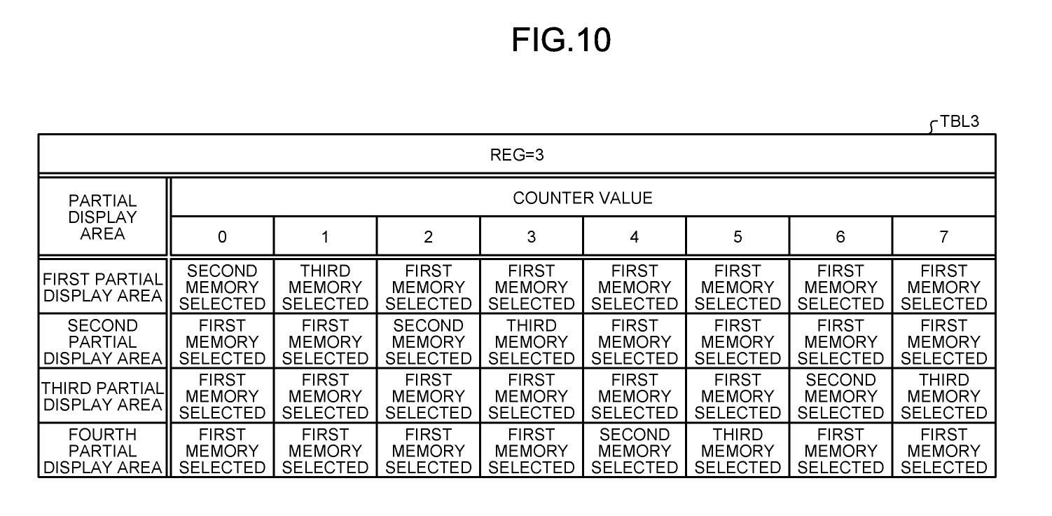

FIG. 10 is a diagram illustrating an example of still another table stored in the storage of the display device according to the first embodiment.

When the value REG is 3, the controller 34b refers to a table TBL3 illustrated in FIG. 10. When the value REG is 3, the controller 34b causes the counter 34a to operate as an octal counter. Consequently, the counter 34a counts 0, 1, 2, 3, 4, 5, 6, 7, 0, . . . in synchronization with the selected clock signal CLK-SEL.

When the counter value is 0, the controller 34b controls the first memory selection signal transmitter 33-1 such that the second memory 52 of each of the sub-pixels SPix in the first partial display area PDA-1 is selected. In order to select the second memory 52 of each of the sub-pixels SPix in the first partial display area PDA-1, the first memory selection signal transmitter 33-1 outputs the memory selection signal MSig to the 1_{b}th memory selection signal supply line L-1_{b}.

When the counter value is 0, the controller 34b controls the second to fourth memory selection signal transmitters 33-2 to 33-4 such that the first memory 51 of each of the sub-pixels SPix in the second to fourth partial display areas PDA-2 to PDA-4 is selected. In order to select the first memory 51 of each of the sub-pixels SPix in the second to fourth partial display areas PDA-2 to PDA-4, the second to fourth memory selection signal transmitters 33-2 to 33-4 output the memory selection signal MSig to the 2ₐth to 4ₐth memory selection signal supply lines L-2ₐ to L-4ₐ, respectively.

With this process, the display device 1 displays the entire image that is a combination of the 1_{b}th, 2ₐth, 3ₐth, and 4ₐth partial images when the counter value is 0.

When the counter value is 1, the controller 34b controls the first memory selection signal transmitter 33-1 such that the third memory 53 of each of the sub-pixels SPix in the first partial display area PDA-1 is selected. In order to select the third memory 53 of each of the sub-pixels SPix in the first partial display area PDA-1, the first memory selection signal transmitter 33-1 outputs the memory selection signal MSig to the 1_{c}th memory selection signal supply line L-1_{c}.

When the counter value is 1, the controller 34b controls the second to fourth memory selection signal transmitters 33-2 to 33-4 such that the first memory 51 of each of the sub-pixels SPix in the second to fourth partial display areas PDA-2 to PDA-4 is selected. In order to select the first memory 51 of each of the sub-pixels SPix in the second to fourth partial display areas PDA-2 to PDA-4, the second to fourth memory selection signal transmitters 33-2 to 33-4 output the memory selection signal MSig to the 2ₐth to 4ₐth memory selection signal supply lines L-2ₐ to L-4ₐ, respectively.

With this process, the display device 1 displays the entire image that is a combination of the 1_{c}th, 2ₐth, 3ₐth, and 4ₐth partial images when the counter value is 1.

When the counter value is 2, the controller 34b controls the first, third, and fourth memory selection signal transmitters 33-1, 33-3, and 33-4 such that the first memory 51 of each of the sub-pixels SPix in the first, third, and fourth partial display areas PDA-1, PDA-3, and PDA-4 is selected. In order to select the first memory 51 of each of the sub-pixels SPix in the first, third, and fourth partial display areas PDA-1, PDA-3, and PDA-4, the first, third, and fourth memory selection signal transmitters 33-1, 33-3, and 33-4 output the memory selection signal MSig to the 1ₐth, 3ₐth, and 4ₐth memory selection signal supply lines L-1ₐ, L-3ₐ, and L-4ₐ, respectively.

When the counter value is 2, the controller 34b controls the second memory selection signal transmitter 33-2 such that the second memory 52 of each of the sub-pixels SPix in the second partial display area PDA-2 is selected. In order to select the second memory 52 of each of the sub-pixels SPix in the second partial display area PDA-2, the second memory selection signal transmitter 33-2 outputs the memory selection signal MSig to the 2_{b}th memory selection signal supply line L-2_{b}.

With this process, the display device 1 displays the entire image that is a combination of the 1ₐth, 2_{b}th, 3ₐth, and 4ₐth partial images when the counter value is 2.

When the counter value is 3, the controller 34b controls the first, third, and fourth memory selection signal transmitters 33-1, 33-3, and 33-4 such that the first memory 51 of each of the sub-pixels SPix in the first, third, and fourth partial display areas PDA-1, PDA-3, and PDA-4 is selected. In order to select the first memory 51 of each of the sub-pixels SPix in the first, third, and fourth partial display areas PDA-1, PDA-3, and PDA-4, the first, third, and fourth memory selection signal transmitters 33-1, 33-3, and 33-4 output the memory selection signal MSig to the 1ₐth, 3ₐth, and 4ₐth memory selection signal supply lines L-1ₐ, L-3ₐ, and L-4ₐ, respectively.

When the counter value is 3, the controller 34b controls the second memory selection signal transmitter 33-2 such that the third memory 53 of each of the sub-pixels SPix in the second partial display area PDA-2 is selected. In order to select the third memory 53 of each of the sub-pixels SPix in the second partial display area PDA-2, the second memory selection signal transmitter 33-2 outputs the memory selection signal MSig to the 2_{c}th memory selection signal supply line L-2_{c}.

With this process, the display device 1 displays the entire image that is a combination of the 1ₐth, 2_{c}th, 3ₐth, and 4ₐth partial images when the counter value is 3.

When the counter value is 4, the controller 34b controls the first to third memory selection signal transmitters 33-1 to 33-3 such that the first memory 51 of each of the sub-pixels SPix in the first to third partial display areas PDA-1 to PDA-3 is selected. In order to select the first memory 51 of each of the sub-pixels SPix in the first to third partial display areas PDA-1 to PDA-3, the first to third memory selection signal transmitters 33-1 to 33-3 output the memory selection signal MSig to the 1ₐth to 3ₐth memory selection signal supply lines L-1ₐ to L-3ₐ, respectively.

When the counter value is 4, the controller 34b controls the fourth memory selection signal transmitter 33-4 such that the second memory 52 of each of the sub-pixels SPix in the fourth partial display area PDA-4 is selected. In order to select the second memory 52 of each of the sub-pixels SPix in the fourth partial display area PDA-4, the fourth memory selection signal transmitter 33-4 outputs the memory selection signal MSig to the 4_{b}th memory selection signal supply line L-4_{b}.

With this process, the display device 1 displays the entire image that is a combination of the 1ₐth, 2ₐth, 3ₐth, and 4_{b}th partial images when the counter value is 4.

When the counter value is 5, the controller 34b controls the first to third memory selection signal transmitters 33-1 to 33-3 such that the first memory 51 of each of the sub-pixels SPix in the first to third partial display areas PDA-1 to PDA-3 is selected. In order to select the first memory 51 of each of the sub-pixels SPix in the first to third partial display areas PDA-1 to PDA-3, the first to third memory selection signal transmitters 33-1 to 33-3 output the memory selection signal MSig to the 1ₐth to 3ₐth memory selection signal supply lines L-1ₐ to L-3ₐ, respectively.

When the counter value is 5, the controller 34b controls the fourth memory selection signal transmitter 33-4 such that the third memory 53 of each of the sub-pixels SPix in the fourth partial display area PDA-4 is selected. In order to select the third memory 53 of each of the sub-pixels SPix in the fourth partial display area PDA-4, the fourth memory selection signal transmitter 33-4 outputs the memory selection signal MSig to the 4_{c}th memory selection signal supply line L-4_{c}.

With this process, the display device 1 displays the entire image that is a combination of the 1ₐth, 2ₐth, 3ₐth, and 4_{c}th partial images when the counter value is 5.

When the counter value is 6, the controller 34b controls the first, second, and fourth memory selection signal transmitters 33-1, 33-2, and 33-4 such that the first memory 51 of each of the sub-pixels SPix in the first, second, and fourth partial display areas PDA-1, PDA-2, and PDA-4 is selected. In order to select the first memory 51 of each of the sub-pixels SPix in the first, second, and fourth partial display areas PDA-1, PDA-2, and PDA-4, the first, second, and fourth memory selection signal transmitters 33-1, 33-2, and 33-4 output the memory selection signal MSig to the 1ₐth, 2ₐth, and 4ₐth memory selection signal supply lines L-1ₐ, L-2ₐ, and L-4ₐ, respectively.

When the counter value is 6, the controller 34b controls the third memory selection signal transmitter 33-3 such that the second memory 52 of each of the sub-pixels SPix in the third partial display area PDA-3 is selected. In order to select the second memory 52 of each of the sub-pixels SPix in the third partial display area PDA-3, the third memory selection signal transmitter 33-3 outputs the memory selection signal MSig to the 3_{b}th memory selection signal supply line L-3_{b}.

With this process, the display device 1 displays the entire image that is a combination of the 1ₐth, 2ₐth, 3_{b}th, and 4ₐth partial images when the counter value is 6.

When the counter value is 7, the controller 34b controls the first, second, and fourth memory selection signal transmitters 33-1, 33-2, and 33-4 such that the first memory 51 of each of the sub-pixels SPix in the first, second, and fourth partial display areas PDA-1, PDA-2, and PDA-4 is selected. In order to select the first memory 51 of each of the sub-pixels SPix in the first, second, and fourth partial display areas PDA-1, PDA-2, and PDA-4, the first, second, and fourth memory selection signal transmitters 33-1, 33-2, and 33-4 output the memory selection signal MSig to the 1ₐth, 2ₐth, and 4ₐth memory selection signal supply lines L-1ₐ, L-2ₐ, and L-4ₐ, respectively.

When the counter value is 7, the controller 34b controls the third memory selection signal transmitter 33-3 such that the third memory 53 of each of the sub-pixels SPix in the third partial display area PDA-3 is selected. In order to select the third memory 53 of each of the sub-pixels SPix in the third partial display area PDA-3, the third memory selection signal transmitter 33-3 outputs the memory selection signal MSig to the 3_{c}th memory selection signal supply line L-3_{c}.

With this process, the display device 1 displays the entire image that is a combination of the 1ₐth, 2ₐth, 3_{c}th, and 4ₐth partial images when the counter value is 7.

The storage 34c may be rewritable. An external circuit may write the tables TBL into the storage 34c. This configuration allows the display device 1 to change the way of changing the first to fourth partial images.

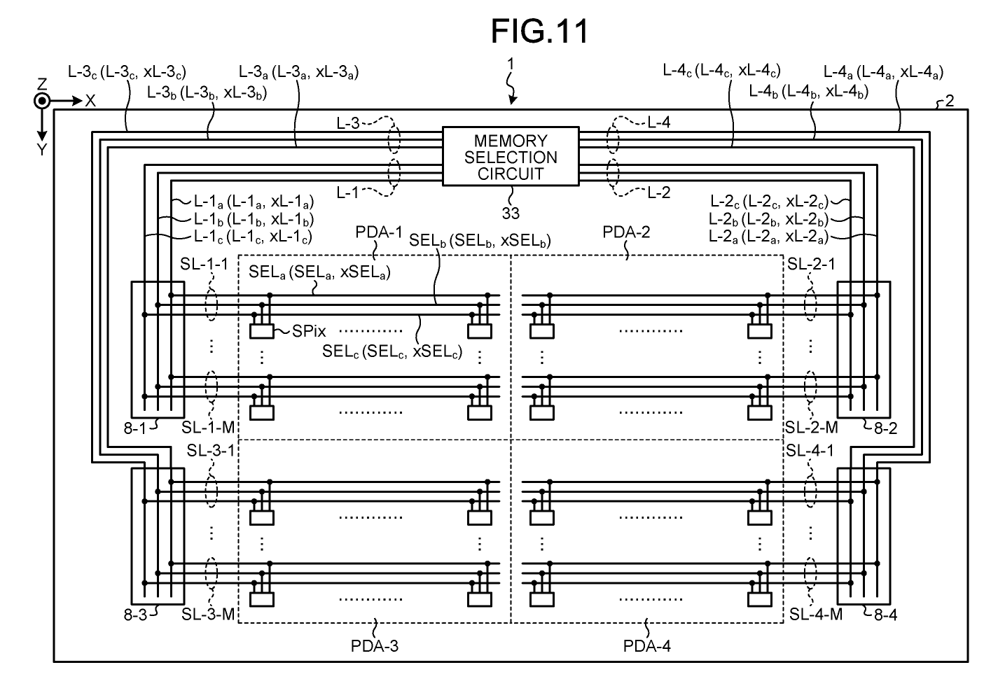

FIG. 11 is a diagram illustrating a coupling relation between the memory selection circuit, the distribution circuit, and the sub-pixels of the display device according to the first embodiment.

The memory selection circuit 33 is coupled to the first to fourth distribution circuits 8-1 to 8-4 through the first to fourth memory selection signal supply line groups L-1 to L-4.

The first distribution circuit 8-1 is coupled to M rows of the sub-pixels SPix in the first partial display area PDA-1 through 1-1th to 1-Mth memory selection line groups SL-1-1 to SL-1-M. Each of the 1-1th to 1-Mth memory selection line groups SL-1-1 to SL-1-M includes first to third memory selection lines SELₐ, SEL_{b}, and SEL_{c}. The first to third memory selection lines SELₐ to SEL_{c} of each row is coupled to the first to third memories 51 to 53 of the row, respectively.

If the sub-pixels SPix are operated by the memory selection signal MSig and the inverted memory selection signal xMSig inverted from the memory selection signal MSig, each of the 1-1th to 1-Mth memory selection line groups SL-1-1 to SL-1-M further includes first to third inverted memory selection lines xSELₐ, xSEL_{b}, and xSEL_{c}.

In the same manner, the second distribution circuit 8-2 is coupled to the M rows of the sub-pixels SPix in the second partial display area PDA-2 through 2-1th to 2-Mth memory selection line groups SL-2-1 to SL-2-M. The third distribution circuit 8-3 is coupled to the M rows of the sub-pixels SPix in the third partial display area PDA-3 through 3-1th to 3-Mth memory selection line groups SL-3-1 to SL-3-M. The fourth distribution circuit 8-4 is coupled to the M rows of the sub-pixels SPix in the fourth partial display area PDA-4 through 4-1th to 4-Mth memory selection line groups SL-4-1 to SL-4-M. Each of the memory selection line groups SL-2-1 to SL-2-M, SL-3-1 to SL-3-M, and SL-4-1 to SL-4-M includes the first to third memory selection lines SELₐ, SEL_{b}, and SEL_{c}. If the sub-pixels SPix are operated by the memory selection signal MSig and the inverted memory selection signal xMSig inverted from the memory selection signal MSig, each of the memory selection line groups SL-2-1 to SL-2-M, SL-3-1 to SL-3-M, and SL-4-1 to SL-4-M further includes the first to third inverted memory selection lines xSELₐ, xSEL_{b}, and xSEL_{c}.

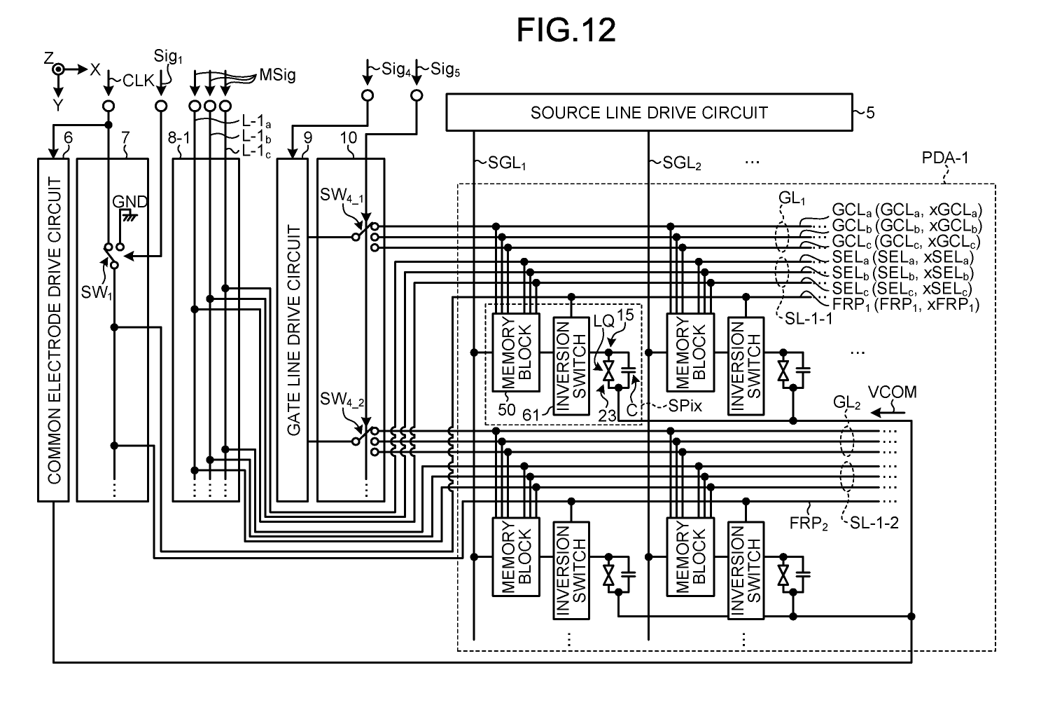

FIG. 12 is a diagram illustrating a circuit configuration of the display device according to the first embodiment. FIG. 12 illustrates 2×2 sub-pixels SPix of the sub-pixels SPix in the first partial display area PDA-1.

The circuit configuration in each of the second to fourth partial display areas PDA-2 to PDA-4 is the same as that in the first partial display area PDA-1, and is therefore neither illustrated nor described.

The sub-pixel SPix includes a liquid crystal LQ, a retention capacitor C, and the sub-pixel electrode 15 (refer to FIG. 2) in addition to the memory block 50 and the inversion switch 61.

The common electrode drive circuit 6 inverts a common potential VCOM common to the sub-pixels SPix in synchronization with the reference clock signal CLK, and outputs the result to the common electrode 23 (refer to FIG. 2). The common electrode drive circuit 6 may output the reference clock signal CLK left unchanged as the common potential VCOM to the common electrode 23, or it may output the reference clock signal CLK as the common potential VCOM through a buffer circuit for amplifying the current driving capacity thereof to the common electrode 23.

The gate line drive circuit 9 includes the (M×2) output terminals corresponding to the (M×2) rows of the pixels Pix. The gate line drive circuit 9 sequentially outputs the gate signal for selecting each of the (M×2) rows from its respective one of the (M×2) output terminals based on a control signal Sig₄ supplied from the timing controller 4b.

The gate line drive circuit 9 may be a scanner circuit that sequentially outputs the gate signals from the (M×2) output terminals based on the control signals Sig₄ (a scan start signal and clock pulse signals). Alternatively, the gate line drive circuit 9 may be a decoder circuit that decodes the encoded control signal Sig₄ and outputs the gate signal to the output terminal specified by the control signal Sig₄.

The gate line selection circuit 10 includes (M×2) switches SW₄_{_}₁, SW₄_{_}₂, . . . corresponding to the (M×2) rows of the pixels Pix. The (M×2) switches SW₄_{_}₁, SW₄_{_}₂, . . . are commonly controlled by a control signal Sig₅ supplied from the timing controller 4b.

(M×2) gate line groups GL₁, GL₂, . . . are arranged corresponding to the (M×2) rows of the pixels Pix on the first panel 2. Each of the (M×2) gate line groups GL₁, GL₂, . . . includes a first gate line GCLₐ, a second gate line GCL_{b}, and a third gate line GCL_{c}. The first gate line GCLₐ is electrically coupled to the first memories 51 (refer to FIG. 3) of a corresponding one of the rows. The second gate line GCL_{b} is electrically coupled to the second memories 52 (refer to FIG. 3) of a corresponding one of the rows. The third gate line GCL_{c} is electrically coupled to the third memories 53 (refer to FIG. 3) of a corresponding one of the rows. Each of the (M×2) gate line groups GL₁, GL₂, . . . extends along the X-direction to the second partial display area PDA-2 in the display area DA (refer to FIG. 1).

When the control signal Sig₅ indicates a first value, each of the (M×2) switches SW₄_{_}₁, SW₄_{_}₂, . . . electrically couples a corresponding one of the output terminals of the gate line drive circuit 9 to the first gate line GCLₐ. When the control signal Sig₅ indicates a second value, each of the (M×2) switches SW₄_{_}₁, SW₄_{_}₂, . . . electrically couples a corresponding one of the output terminals of the gate line drive circuit 9 to the second gate line GCL_{b}. When the control signal Sig₅ indicates a third value, each of the (M×2) switches SW₄_{_}₁, SW₄_{_}₂, . . . electrically couples a corresponding one of the output terminals of the gate line drive circuit 9 to the third gate line GCL_{c}.

When the output terminal of the gate line drive circuit 9 is electrically coupled to the first gate line GCLₐ, the gate signal is supplied to the first memory 51 of each of the sub-pixels SPix. When the output terminal of the gate line drive circuit 9 is electrically coupled to the second gate line GCL_{b}, the gate signal is supplied to the second memory 52 of each of the sub-pixels SPix. When the output terminal of the gate line drive circuit 9 is electrically coupled to the third gate line GCL_{c}, the gate signal is supplied to the third memory 53 of each of the sub-pixels SPix.

(N×2)×3 source lines SGL₁, SGL₂, . . . are arranged corresponding to the (N×2)×3 columns of the sub-pixels SPix on the first panel 2. Each of the source lines SGL₁, SGL₂, . . . extends along the Y-direction to the third and fourth partial display areas PDA-3 and PDA-4 in the display area DA (refer to FIG. 1).

The source line drive circuit 5 outputs the sub-pixel data to one memory among the three memories of each the sub-pixels SPix, which is selected by the gate signal, through the source lines SGL₁, SGL₂, . . . .

Each of the sub-pixels SPix of the row supplied with the gate signal stores the sub-pixel data supplied to the source lines SGL into one of the first to third memories 51 to 53 corresponding to the gate line GCL supplied with the gate signal.

The first distribution circuit 8-1 electrically couples the 1ₐth memory selection signal supply line L-1, to the first memory selection line SELₐ of each of the 1-1th to 1-Mth memory selection line groups SL-1-1 to SL-1-M. When the memory selection signal MSig is supplied from the memory selection circuit 33 to the 1ₐth memory selection signal supply line L-1ₐ, the first distribution circuit 8-1 supplies the memory selection signal MSig to the M first memory selection lines SELₐ. The first distribution circuit 8-1 may include one or a plurality of buffers for amplifying the memory selection signal MSig.

The first distribution circuit 8-1 electrically couples the 1_{b}th memory selection signal supply line L-1_{b} to the second memory selection line SEL_{b} of each of the 1-1th to 1-Mth memory selection line groups SL-1-1 to SL-1-M. When the memory selection signal MSig is supplied from the memory selection circuit 33 to the 1_{b}th memory selection signal supply line L-1_{b}, the first distribution circuit 8-1 supplies the memory selection signal MSig to the M second memory selection lines SEL_{b}.

The first distribution circuit 8-1 electrically couples the 1_{c}th memory selection signal supply line L-1_{c} to the third memory selection line SEL_{c} of each of the 1-1th to 1-Mth memory selection line groups SL-1-1 to SL-1-M. When the memory selection signal MSig is supplied from the memory selection circuit 33 to the 1_{c}th memory selection signal supply line L-1_{c}, the first distribution circuit 8-1 supplies the memory selection signal MSig to the M third memory selection lines SEL_{c}.

Each of the sub-pixels SPix modulates the liquid crystal layer based on the sub-pixel data stored in one of the first to third memories 51 to 53 corresponding to the memory selection line supplied with the memory selection signal MSig. As a result, the first partial image is displayed in the first partial display area PDA-1.

M display signal lines FRP₁, FRP₂, . . . are arranged corresponding to the M rows of the pixels Pix on the first panel 2. Each of the M display signal lines FRP₁, FRP₂, . . . extends in the X-direction in the display area DA (refer to FIG. 1). If the inversion switch 61 is operated by the display signal and an inverted display signal inverted from the display signal, the display signal line FRP and a second display signal line xFRP are provided for each of the rows.

The one or two display signal lines arranged for each of the rows correspond to a display signal line of the present disclosure.

The inversion drive circuit 7 includes a switch SW₁. The switch SW₁ is controlled by a control signal Sig₁ supplied from the timing controller 4b. When the control signal Sig₁ indicates a first value, the switch SW₁ supplies the reference clock signal CLK to each of the display signal lines FRP₁, FRP₂, . . . . When the control signal Sig₁ indicates a second value, the switch SW₁ supplies a reference potential (ground potential) GND to each of the display signal lines FRP₁, FRP₂, . . . .

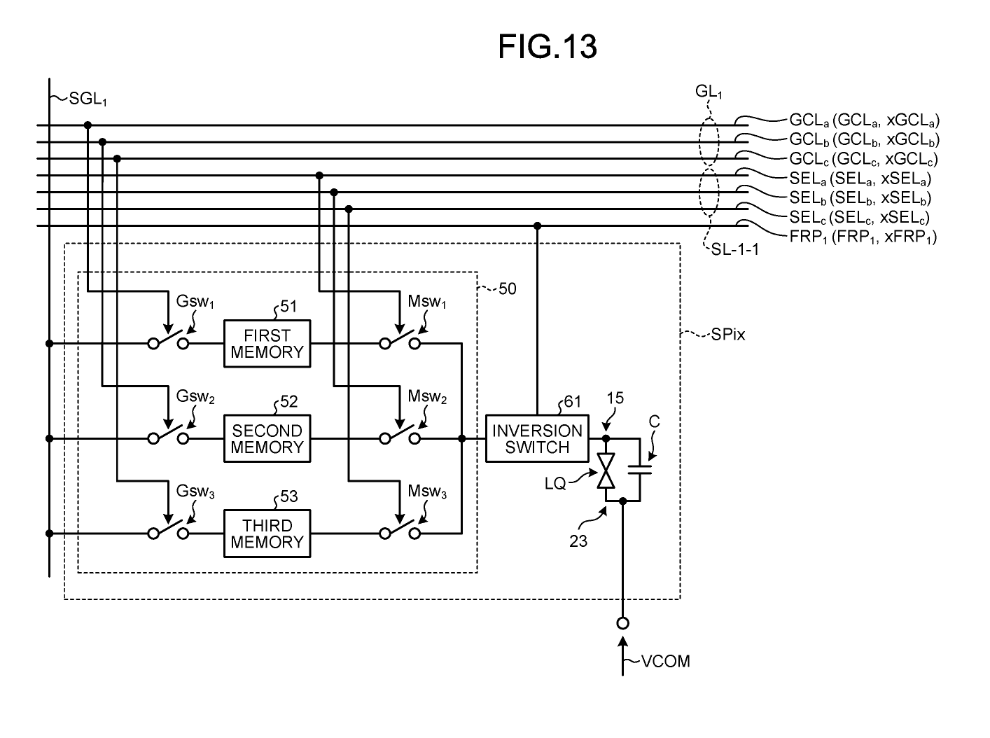

FIG. 13 is a diagram illustrating a circuit configuration of each of the sub-pixels of the display device according to the first embodiment. FIG. 13 illustrates one of the sub-pixels SPix.

The sub-pixel SPix includes the memory block 50. The memory block 50 includes the first memory 51, the second memory 52, the third memory 53, switches Gsw₁ to Gsw₃, and switches Msw₁ to Msw₃.

A control input terminal of the switch Gsw₁ is electrically coupled to the first gate line GCLₐ. Supplying the gate signal at a high level to the first gate line GCLₐ turns on the switch Gsw₁ to electrically couple the source line SGL₁ to an input terminal of the first memory 51. This operation stores the sub-pixel data supplied to the source line SGL₁ into the first memory 51.

A control input terminal of the switch Gsw₂ is electrically coupled to the second gate line GCL_{b}. Supplying the high-level gate signal to the second gate line GCL_{b} turns on the switch Gsw₂ to electrically couple the source line SGL₁ to an input terminal of the second memory 52. This operation stores the sub-pixel data supplied to the source line SGL₁ into the second memory 52.

A control input terminal of the switch Gsw₃ is electrically coupled to the third gate line GCL_{c}. Supplying the high-level gate signal to the third gate line GCL_{c} turns on the switch Gsw₃ to electrically couple the source line SGL₁ to an input terminal of the third memory 53. This operation stores the sub-pixel data supplied to the source line SGL₁ into the third memory 53.

If the switches Gsw₁ to Gsw₃ are operated by the high-level gate signal, the gate line group GL₁ includes the first to third gate lines GCLₐ to GCL_{c}, as illustrated in FIG. 13. Examples of the switches operated by the high-level gate signal include n-channel transistors, but the present disclosure is not limited thereto.

If, instead, the switches Gsw₁ to Gsw₃ are operated by the gate signal and the inverted gate signal inverted from the gate signal, the gate line group GL₁ further includes fourth to sixth gate lines xGCLₐ to xGCL_{c} capable of being supplied with the inverted gate signal, in addition to the first to third gate lines GCLₐ to GCL_{c}. Examples of the switches operated by the gate signal and the inverted gate signal include transfer gates, but the present disclosure is not limited thereto.

The inverted gate signal can be supplied to the fourth gate line xGCLₐ by providing an inverter circuit having an input terminal electrically coupled to the first gate line GCLₐ and an output terminal electrically coupled to the fourth gate line xGCLₐ. In the same manner, the inverted gate signal can be supplied to the fifth gate line xGCL_{b} by providing an inverter circuit having an input terminal electrically coupled to the second gate line GCL_{b} and an output terminal electrically coupled to the fifth gate line xGCL_{b}. In the same manner, the inverted gate signal can be supplied to the sixth gate line xGCL_{c} by providing an inverter circuit having an input terminal electrically coupled to the third gate line GCL_{c} and an output terminal electrically coupled to the sixth gate line xGCL_{c}.

A control input terminal of the switch Msw₁ is electrically coupled to the first memory selection line SELₐ. Supplying the memory selection signal MSig at a high level to the first memory selection line SELₐ turns on the switch Msw₁ to electrically couple an output terminal of the first memory 51 to an input terminal of the inversion switch 61. This operation supplies the sub-pixel data stored in the first memory 51 to the inversion switch 61.

A control input terminal of the switch Msw₂ is electrically coupled to the second memory selection line SEL_{b}. Supplying the high-level memory selection signal MSig to the second memory selection line SEL_{b} turns on the switch Msw₂ to electrically couple an output terminal of the second memory 52 to the input terminal of the inversion switch 61. This operation supplies the sub-pixel data stored in the second memory 52 to the inversion switch 61.

A control input terminal of the switch Msw₃ is electrically coupled to the third memory selection line SEL_{c}. Supplying the high-level memory selection signal MSig to the third memory selection line SEL_{c} turns on the switch Msw₃ to electrically couple an output terminal of the third memory 53 to the input terminal of the inversion switch 61. This operation supplies the sub-pixel data stored in the third memory 53 to the inversion switch 61.

If the switches Msw₁ to Msw₃ are operated by the high-level memory selection signal MSig, the 1-1th memory selection line group SL-1-1 includes the first to third memory selection lines SELₐ to SEL_{c}, as illustrated in FIG. 13. Examples of the switches operated by the high-level memory selection signal MSig include the n-channel transistors, but the present disclosure is not limited thereto.

If, instead, the switches Msw₁ to Msw₃ are operated by the memory selection signal MSig and the inverted memory selection signal xMSig inverted from the memory selection signal MSig, the 1-1th memory selection line group SL-1-1 further includes the first to third inverted memory selection lines xSELₐ to xSEL_{c} capable of being supplied with the inverted memory selection signal xMSig, in addition to the first to third memory selection lines SELₐ to SEL_{c}. Examples of the switches operated by the memory selection signal MSig and the inverted memory selection signal xMSig include the transfer gates, but the present disclosure is not limited thereto.

The inverted memory selection signal xMSig can be supplied to the first inverted memory selection line xSELₐ by providing an inverter circuit having an input terminal electrically coupled to the first memory selection line SELₐ and an output terminal electrically coupled to the first inverted memory selection line xSELₐ. In the same manner, the inverted memory selection signal xMSig can be supplied to the second inverted memory selection line xSEL_{b} by providing an inverter circuit having an input terminal electrically coupled to the second memory selection line SEL_{b} and an output terminal electrically coupled to the second inverted memory selection line xSEL_{b}. In the same manner, the inverted memory selection signal xMSig can be supplied to the third inverted memory selection line xSEL_{c} by providing an inverter circuit having an input terminal electrically coupled to the third memory selection line SEL_{c} and an output terminal electrically coupled to the third inverted memory selection line xSEL_{c}.

The display signal line FRP₁ supplies the inversion switch 61 with the display signal inverted in synchronization with the reference clock signal CLK. Based on the display signal, the inversion switch 61 supplies the sub-pixel data stored in the first memory 51, the second memory 52, or the third memory 53 unchanged or in an inverted form to the sub-pixel electrode 15. The liquid crystal LQ and the retention capacitor C are provided between the sub-pixel electrode 15 and the common electrode 23. The retention capacitor C retains the voltage between the sub-pixel electrode 15 and the common electrode 23. The orientation of the liquid crystal molecules in the liquid crystal LQ changes according to the voltage between the sub-pixel electrode 15 and the common electrode 23, and a sub-pixel image is displayed. A configuration provided with no retention capacitor can also be employed.

If the inversion switch 61 is operated by the display signal, one display signal line FRP₁ is provided as illustrated in FIG. 13. If, instead, the inversion switch 61 is operated by the display signal and the inverted display signal inverted from the display signal, the second display signal line xFRP₁ is further provided in addition to the display signal line FRP₁ (first display signal line FRP₁). The inverted display signal can be supplied to the second display signal line xFRP₁ by providing an inverter circuit having an input terminal electrically coupled to the display signal line FRP₁ and an output terminal electrically coupled to the second display signal line xFRP₁. In this case, the inversion switch 61 supplies the display signal from the first display signal line FRP₁ or the second display signal line xFRP₁ to the sub-pixel electrode 15 based on the sub-pixel data stored in the first memory 51, the second memory 52, or the third memory 53.

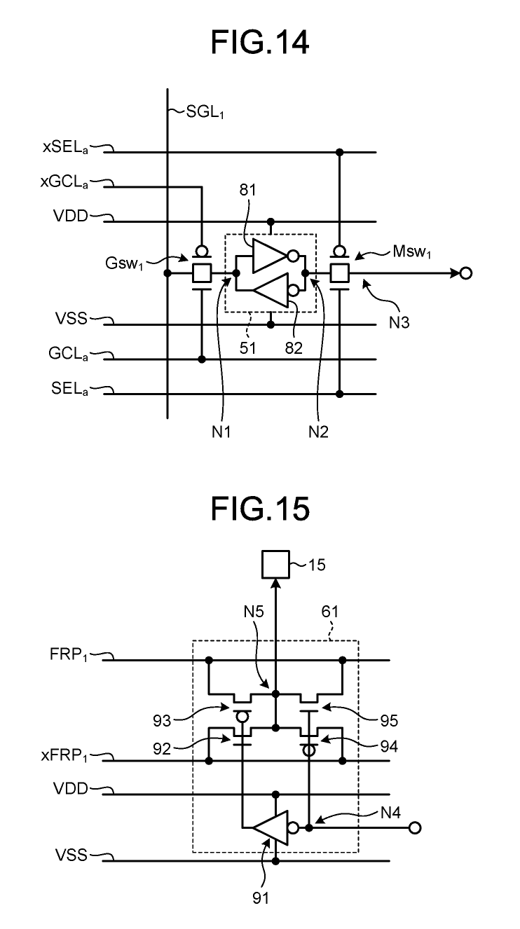

FIG. 14 is a diagram illustrating a circuit configuration of one of the memories in the sub-pixel of the display device according to the first embodiment. FIG. 14 is a diagram illustrating the circuit configuration of the first memory 51. The circuit configuration of each of the second memory 52 and the third memory 53 is the same as that of the first memory 51, and is therefore neither illustrated nor described.

The first memory 51 has a static random access memory (SRAM) cell structure that includes an inverter circuit 81 and an inverter circuit 82 electrically coupled in parallel in a direction opposite to the inverter circuit 81. An input terminal of the inverter circuit 81 and an output terminal of the inverter circuit 82 constitute a node N1, and an output terminal of the inverter circuit 81 and an input terminal of the inverter circuit 82 constitute a node N2. The inverter circuit 81 and the inverter circuit 82 operate using power supplied from a power supply line VDD on a high-potential side and a power supply line VSS on a low-potential side.

The node N1 is electrically coupled to an output terminal of the switch Gsw₁. The node N2 is electrically coupled to an input terminal of the switch Msw₁.

FIG. 14 illustrates an example in which a transfer gate is used as the switch Gsw₁. One control input terminal of the switch Gsw₁ is electrically coupled to the first gate line GCLₐ. The other control input terminal of the switch Gsw₁ is electrically coupled to the fourth gate line xGCLₐ. The fourth gate line xGCLₐ is supplied with the inverted gate signal inverted from the gate signal supplied to the first gate line GCLₐ.

An input terminal of the switch Gsw₁ is electrically coupled to the source line SGL₁. The output terminal of the switch Gsw₁ is electrically coupled to the node N1. When the gate signal supplied to the first gate line GCLₐ is set to the high level and the inverted gate signal supplied to the fourth gate line xGCLₐ is set to the low level, the switch Gsw₁ is turned on to electrically couple the source line SGL₁ to the node N1. This operation stores the sub-pixel data supplied to the source line SGL₁ into the first memory 51.

FIG. 14 illustrates an example in which a transfer gate is used as the switch Msw₁. One control input terminal of the switch Msw₁ is electrically coupled to the first memory selection line SELₐ. The other control input terminal of the switch Msw₁ is electrically coupled to the first inverted memory selection line xSELₐ. The first inverted memory selection line xSELₐ is supplied with the inverted memory selection signal xMSig inverted from the memory selection signal MSig supplied to the first memory selection line SELₐ.

The input terminal of the switch Msw₁ is electrically coupled to the node N2. An output terminal of the switch Msw₁ is coupled to a node N3. The node N3 is an output node of the first memory 51, and is electrically coupled to the inversion switch 61 (refer to FIG. 13). When the memory selection signal MSig supplied to the first memory selection line SELₐ is set to the high level and the inverted memory selection signal supplied to the first inverted memory selection line xSELₐ is set to the low level, the switch Msw₁ is turned on. This operation electrically couples the node N2 to the input terminal of the inversion switch 61 through the switch Msw₁ and the node N3. This operation, in turn, supplies the sub-pixel data stored in the first memory 51 to the inversion switch 61.

When both the switches Gsw₁ and Msw₁ are off, the sub-pixel data circulates in a loop formed by the inverter circuits 81 and 82. Consequently, the first memory 51 continues retaining the sub-pixel data.

In the first embodiment, the exemplary case has been described where the first memory 51 is an SRAM. However, the present disclosure is not limited thereto. Other examples of the first memory 51 include a dynamic random access memory (DRAM).

FIG. 15 is a diagram illustrating a circuit configuration of the inversion switch of the sub-pixel of the display device according to the first embodiment. The inversion switch 61 includes an inverter circuit 91, re-channel transistors 92 and 95, and p-channel transistors 93 and 94.

An input terminal of the inverter circuit 91, a gate terminal of the p-channel transistor 94, and a gate terminal of the n-channel transistor 95 are coupled to a node N4. The node N4 is an input node of the inversion switch 61 and is electrically coupled to the nodes N3 of the first memory 51, the second memory 52, and the third memory 53. The node N4 is supplied with the sub-pixel data from the first memory 51, the second memory 52, or the third memory 53. The inverter circuit 91 operates using power supplied from the power supply line VDD on the high-potential side and the power supply line VSS on the low-potential side.

One of the source and the drain of the n-channel transistor 92 is electrically coupled to the second display signal line xFRP₁. The other of the source and the drain of the n-channel transistor 92 is electrically coupled to a node N5.

One of the source and the drain of the p-channel transistor 93 is electrically coupled to the display signal line FRP₁. The other of the source and the drain of the p-channel transistor 93 is electrically coupled to the node N5.

One of the source and the drain of the p-channel transistor 94 is electrically coupled to the second display signal line xFRP₁. The other of the source and the drain of the p-channel transistor 94 is electrically coupled to the node N5.

One of the source and the drain of the n-channel transistor 95 is electrically coupled to the display signal line FRP₁. The other of the source and the drain of the re-channel transistor 95 is electrically coupled to the node N5.

The node N5 is an output node of the inversion switch 61 and is electrically coupled to the reflective electrode (sub-pixel electrode) 15.

When the sub-pixel data supplied from the first memory 51, the second memory 52, or the third memory 53 is at the high level, the output signal of the inverter circuit 91 is at the low level. When the output signal of the inverter circuit 91 is at the low level, the n-channel transistor 92 is off, and the p-channel transistor 93 is on.

When the sub-pixel data supplied from the first memory 51, the second memory 52, or the third memory 53 is at the high level, the p-channel transistor 94 is off, and the re-channel transistor 95 is on.

Thus, when the sub-pixel data supplied from the first memory 51, the second memory 52, or the third memory 53 is at the high level, the display signal supplied to the display signal line FRP₁ is supplied to the sub-pixel electrode 15 through the p-channel transistor 93 and the re-channel transistor 95.

The display signal (first display signal) supplied to the display signal line FRP₁ is inverted in synchronization with the reference clock signal CLK. The common potential supplied to the common electrode 23 is also inverted in phase with the display signal in synchronization with the reference clock signal CLK. When the display signal is in phase with the common potential, no voltage is applied to the liquid crystal LQ, so that the orientation of the liquid crystal molecules does not change. As a result, the sub-pixel SPix is placed in a black display state (a state of not transmitting the reflected light, that is, a state where the reflected light does not pass through the color filter and no color is displayed). Thus, the display device 1 can use the common inversion driving method.

When the sub-pixel data supplied from the first memory 51, the second memory 52, or the third memory 53 is at the low level, the output signal of the inverter circuit 91 is at the high level. When the output signal of the inverter circuit 91 is at the high level, the n-channel transistor 92 is on, and the p-channel transistor 93 is off.

When the sub-pixel data supplied from the first memory 51, the second memory 52, or the third memory 53 is at the low level, the p-channel transistor 94 is on, and the re-channel transistor 95 is off.

Thus, when the sub-pixel data supplied from the first memory 51, the second memory 52, or the third memory 53 is at the low level, the inverted display signal supplied to the second display signal line xFRP₁ is supplied to the sub-pixel electrode 15 through the n-channel transistor 92 and the p-channel transistor 94.

The inverted display signal supplied to the second display signal line xFRP₁ is inverted in synchronization with the reference clock signal CLK. The common potential supplied to the common electrode 23 is inverted out of phase with the display signal and in synchronization with the reference clock signal CLK. When the display signal is out of phase with the common potential, a voltage is applied to the liquid crystal LQ, so that the orientation of the liquid crystal molecules changes. As a result, the sub-pixel SPix is placed in a white display state (a state of transmitting the reflected light, that is, a state where the reflected light passes through the color filter and a color is displayed). Thus, the display device 1 can use the common inversion driving method. In this embodiment, the common potential is inverted out of the phase with the inverted display signal.

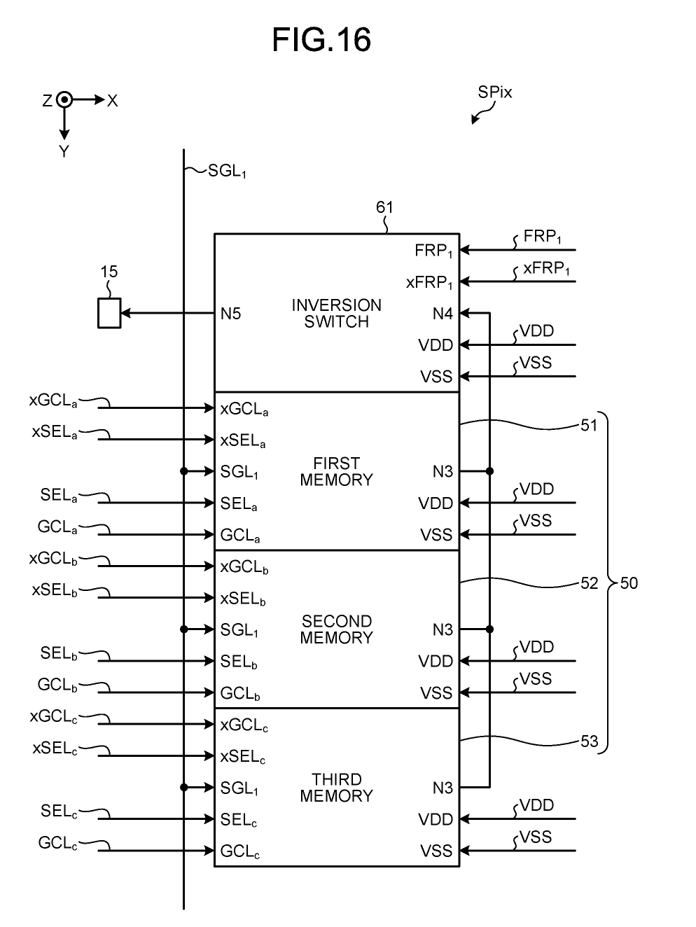

FIG. 16 is a diagram illustrating an overview of a layout of the sub-pixel of the display device according to the first embodiment.

The inversion switch 61, the first memory 51, the second memory 52, and the third memory 53 are arranged in the Y-direction. The nodes N3 serving as output nodes of the first memory 51, the second memory 52, and the third memory 53 are electrically coupled to the node N4 serving as the input node of the inversion switch 61. The node N5 serving as the output node of the inversion switch 61 is electrically coupled to the sub-pixel electrode 15.

The first memory 51 is electrically coupled to the first gate line GCLₐ, the fourth gate line xGCLₐ, the first memory selection line SELₐ, the first inverted memory selection line xSELₐ, the source line SGL₁, the power supply line VDD on the high-potential side, and the power supply line VSS on the low-potential side.

The second memory 52 is electrically coupled to the second gate line GCL_{b}, the fifth gate line xGCL_{b}, the second memory selection line SEL_{b}, the second inverted memory selection line xSEL_{b}, the source line SGL₁, the power supply line VDD on the high-potential side, and the power supply line VSS on the low-potential side.

The third memory 53 is electrically coupled to the third gate line GCL_{c}, the sixth gate line xGCL_{c}, the third memory selection line SEL_{c}, the third inverted memory selection line xSEL_{c}, the source line SGL₁, the power supply line VDD on the high-potential side, and the power supply line VSS on the low-potential side.

The inversion switch 61 is electrically coupled to the display signal line FRP₁, the second display signal line xFRP₁, the power supply line VDD on the high-potential side, and the power supply line VSS on the low-potential side.

### First Operation Example

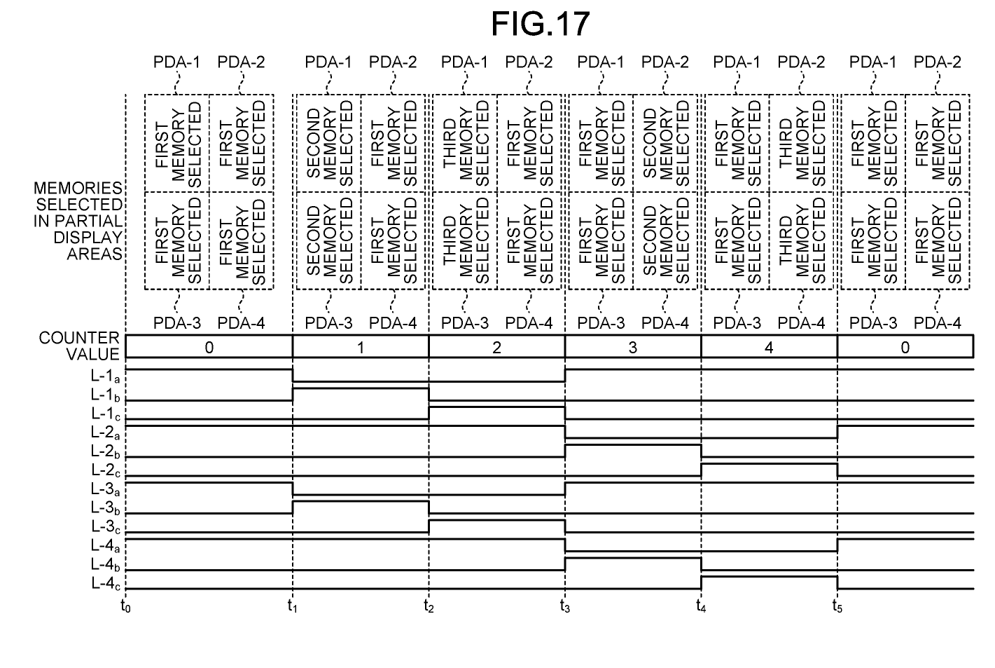

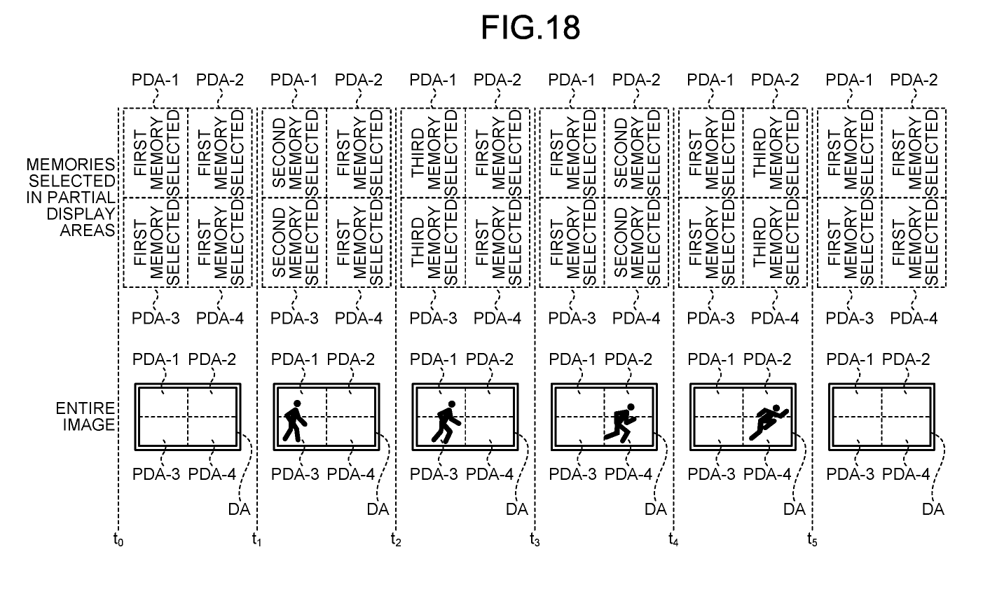

FIG. 17 is a timing diagram illustrating first operation timing of the display device according to the first embodiment. FIG. 18 is a diagram illustrating the entire image displayed in the first operation of the display device according to the first embodiment.

In a first operation example, one significant image is displayed in the display area DA. In other words, the sub-pixels SPix in the first to fourth partial display areas PDA-1 to PDA-4 cooperate to display one significant image. The term “significant image” refers to a meaningful image.

FIG. 17 is a timing diagram illustrating the operation timing of the display device 1 when the value REG is 2. When the value REG is 2, the controller 34b refers to the table TBL2 (refer to FIG. 9).

At the initial time t₀, the counter value of the counter 34a is 0. Consequently, the controller 34b controls the first to fourth memory selection signal transmitters 33-1 to 33-4 such that the first memory 51 of each of the sub-pixels SPix in the first to fourth partial display areas PDA-1 to PDA-4 is selected.

In order to select the first memory 51 of each of the sub-pixels SPix in the first to fourth partial display areas PDA-1 to PDA-4, the first to fourth memory selection signal transmitters 33-1 to 33-4 output the memory selection signal MSig to the 1ₐth to 4ₐth memory selection signal supply lines L-1ₐ to L-4ₐ, respectively.

With this process, the display device 1 displays the entire image that is a combination of the 1ₐth to 4ₐth partial images at time t₀.

Referring to FIG. 18, at time t₀, the 1ₐth to 4ₐth partial images are displayed in the first to fourth partial display areas PDA-1 to PDA-4, respectively. The 1ₐth to 4ₐth partial images are a background image.

Referring again to FIG. 17, at the subsequent time t₁, the counter value of the counter 34a is 1. Consequently, the controller 34b controls the first and third memory selection signal transmitters 33-1 and 33-3 such that the second memory 52 of each of the sub-pixels SPix in the first and third partial display areas PDA-1 and PDA-3 is selected. The controller 34b also controls the second and fourth memory selection signal transmitters 33-2 and 33-4 such that the first memory 51 of each of the sub-pixels SPix in the second and fourth partial display areas PDA-2 and PDA-4 is selected.

In order to select the second memory 52 of each of the sub-pixels SPix in the first and third partial display areas PDA-1 and PDA-3, the first and third memory selection signal transmitters 33-1 and 33-3 output the memory selection signal MSig to the 1_{b}th and 3_{b}th memory selection signal supply lines L-1_{b} and L-3_{b}, respectively.

In order to select the first memory 51 of each of the sub-pixels SPix in the second and fourth partial display areas PDA-2 and PDA-4, the second and fourth memory selection signal transmitters 33-2 and 33-4 output the memory selection signal MSig to the 2ₐth and 4ₐth memory selection signal supply lines L-2, and L-4ₐ, respectively.

With this process, the display device 1 displays the entire image that is a combination of the 1_{b}th, 2ₐth, 3_{b}th, and 4ₐth partial images at time t₁.

Referring to FIG. 18, at time t₁, the 1_{b}th, 2ₐth, 3_{b}th, and 4ₐth partial images are displayed in the first to fourth partial display areas PDA-1 to PDA-4, respectively. The 1_{b}th and 3_{b}th partial images are an image of a person. The 2ₐth and 4ₐth partial images are a background image.

Referring again to FIG. 17, at the subsequent time t₂, the counter value of the counter 34a is 2. Consequently, the controller 34b controls the first and third memory selection signal transmitters 33-1 and 33-3 such that the third memory 53 of each of the sub-pixels SPix in the first and third partial display areas PDA-1 and PDA-3 is selected. The controller 34b also controls the second and fourth memory selection signal transmitters 33-2 and 33-4 such that the first memory 51 of each of the sub-pixels SPix in the second and fourth partial display areas PDA-2 and PDA-4 is selected.

In order to select the third memory 53 of each of the sub-pixels SPix in the first and third partial display areas PDA-1 and PDA-3, the first and third memory selection signal transmitters 33-1 and 33-3 output the memory selection signal MSig to the 1ₐth and 3ₐth memory selection signal supply lines L-1ₐ and L-3ₐ, respectively.

In order to select the first memory 51 of each of the sub-pixels SPix in the second and fourth partial display areas PDA-2 and PDA-4, the second and fourth memory selection signal transmitters 33-2 and 33-4 output the memory selection signal MSig to the 2ₐth and 4ₐth memory selection signal supply lines L-2ₐ and L-4ₐ, respectively.

With this process, the display device 1 displays the entire image that is a combination of the 1ₐth, 2ₐth, 3_{c}th, and 4ₐth partial images at time t₂.

Referring to FIG. 18, at time t₂, the 1ₐth, 2ₐth, 3ₐth, and 4ₐth partial images are displayed in the first to fourth partial display areas PDA-1 to PDA-4, respectively. The 1ₐth and 3ₐth partial images are an image of the person starting to move. The 2ₐth and 4ₐth partial images are a background image.

Referring again to FIG. 17, at the subsequent time t₃, the counter value of the counter 34a is 3. Consequently, the controller 34b controls the first and third memory selection signal transmitters 33-1 and 33-3 such that the first memory 51 of each of the sub-pixels SPix in the first and third partial display areas PDA-1 and PDA-3 is selected. When the counter value is 3, the controller 34b also controls the second and fourth memory selection signal transmitters 33-2 and 33-4 such that the second memory 52 of each of the sub-pixels SPix in the second and fourth partial display areas PDA-2 and PDA-4 is selected.

In order to select the first memory 51 of each of the sub-pixels SPix in the first and third partial display areas PDA-1 and PDA-3, the first and third memory selection signal transmitters 33-1 and 33-3 output the memory selection signal MSig to the 1ₐth and 3ₐth memory selection signal supply lines L-1ₐ and L-3ₐ, respectively.

In order to select the second memory 52 of each of the sub-pixels SPix in the second and fourth partial display areas PDA-2 and PDA-4, the second and fourth memory selection signal transmitters 33-2 and 33-4 output the memory selection signal MSig to the 2_{b}th and 4_{b}th memory selection signal supply lines L-2_{b} and L-4_{b}, respectively.

With this process, the display device 1 displays the entire image that is a combination of the 1ₐth, 2_{b}th, 3ₐth, and 4_{b}th partial images at time t₃.

Referring to FIG. 18, at time t₃, the 1ₐth, 2_{b}th, 3ₐth, and 4_{b}th partial images are displayed in the first to fourth partial display areas PDA-1 to PDA-4, respectively. The 1ₐth and 3ₐth partial images are a background image. The 2_{b}th and 4_{b}th partial images are an image of the person starting to run.

Referring again to FIG. 17, at the subsequent time t₄, the counter value of the counter 34a is 4. Consequently, the controller 34b controls the first and third memory selection signal transmitters 33-1 and 33-3 such that the first memory 51 of each of the sub-pixels SPix in the first and third partial display areas PDA-1 and PDA-3 is selected. When the counter value is 4, the controller 34b also controls the second and fourth memory selection signal transmitters 33-2 and 33-4 such that the third memory 53 of each of the sub-pixels SPix in the second and fourth partial display areas PDA-2 and PDA-4 is selected.

In order to select the first memory 51 of each of the sub-pixels SPix in the first and third partial display areas PDA-1 and PDA-3, the first and third memory selection signal transmitters 33-1 and 33-3 output the memory selection signal MSig to the 1ₐth and 3ₐth memory selection signal supply lines L-1ₐ and L-3ₐ, respectively.

In order to select the third memory 53 of each of the sub-pixels SPix in the second and fourth partial display areas PDA-2 and PDA-4, the second and fourth memory selection signal transmitters 33-2 and 33-4 output the memory selection signal MSig to the 2_{c}th and 4_{c}th memory selection signal supply lines L-2_{c} and L-4_{c}, respectively.

With this process, the display device 1 displays the entire image that is a combination of the 1ₐth, 2_{c}th, 3ₐth, and 4_{c}th partial images when the counter value is 4.

Referring to FIG. 18, at time t₄, the 1ₐth, 2_{c}th, 3ₐth, and 4_{c}th partial images are displayed in the first to fourth partial display areas PDA-1 to PDA-4, respectively. The 1ₐth and 3ₐth partial images are a background image. The 2_{c}th and 4_{c}th partial images are an image of the person running at full speed.

Referring again to FIG. 17, at the subsequent time t₅, the counter value of the counter 34a is 0. Consequently, the controller 34b controls the first to fourth memory selection signal transmitters 33-1 to 33-4 such that the first memory 51 of each of the sub-pixels SPix in the first to fourth partial display areas PDA-1 to PDA-4 is selected.

In order select the first memory 51 of each of the sub-pixels SPix in the first to fourth partial display areas PDA-1 to PDA-4, the first to fourth memory selection signal transmitters 33-1 to 33-4 output the memory selection signal MSig to the 1ₐth to 4ₐth memory selection signal supply lines L-1, to L-4ₐ, respectively.

With this process, the display device 1 displays the entire image that is a combination of the 1ₐth to 4ₐth partial images at time t₅.

Referring to FIG. 18, at time t₅, the 1ₐth to 4ₐth partial images are displayed in the first to fourth partial display areas PDA-1 to PDA-4, respectively. The 1ₐth to 4ₐth partial images are a background image.

As illustrated in FIG. 18, the display device 1 handles each of the first to fourth partial display areas PDA-1 to PDA-4 as the selection unit. The display device 1 simultaneously selects, in one selection unit at a time, one of the first to third memories in each of the sub-pixels SPix in that selection unit. Consequently, the display device 1 can change the entire image in a short period of time by switching the selection of the first to third memories 51 to 53 of each of the sub-pixels SPix in the first to fourth partial display areas PDA-1 to PDA-4. The display device 1 can also perform the animation display (moving image display) by sequentially switching the selection of the first to third memories 51 to 53 of each of the sub-pixels SPix in the first to fourth partial display areas PDA-1 to PDA-4.

The display device 1 simultaneously selects, in one selection unit at a time, one of the first to third memories 51 to 53 in each of the sub-pixels SPix in that selection unit. Consequently, although each of the sub-pixels SPix has only three memories of the first to third memories 51 to 53, the display device 1 can display four different entire images illustrated at time t₀ to t₄. As a result, the display device 1 can perform the smooth animation display.

The display device 1 does not switch the memory of each of the sub-pixels SPix in the partial display area PDA in which the partial display image does not change. For example, at the transition from time t₀ to t₁, the display device 1 does not switch the memory of each of the sub-pixels SPix in the second and fourth partial display areas PDA-2 and PDA-4. This configuration allows the display device 1 to reduce power consumption when the entire image changes.

### Second Operation Example

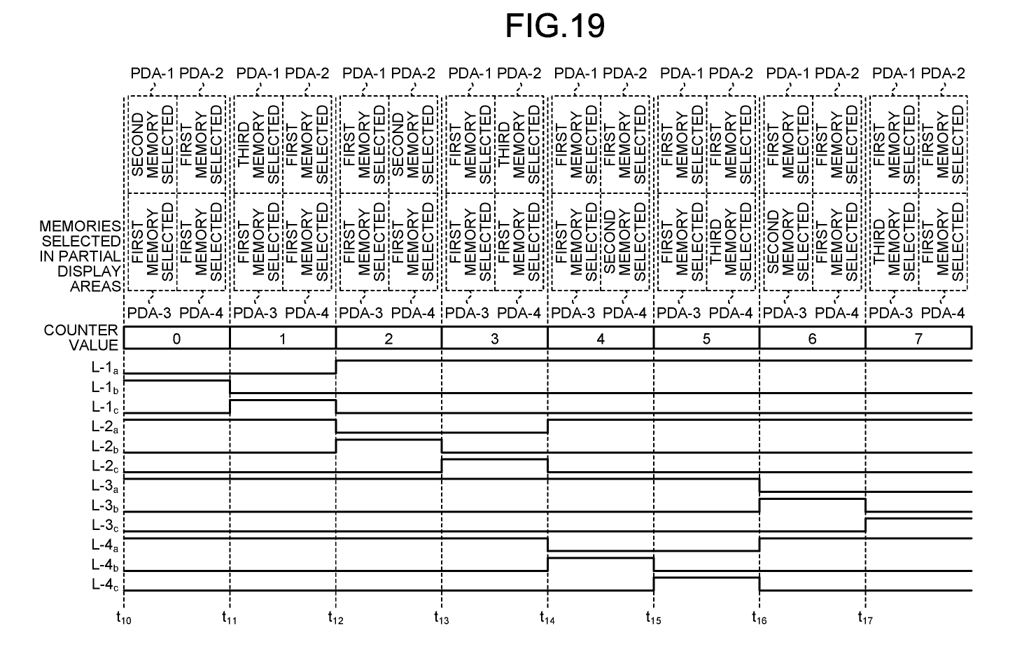

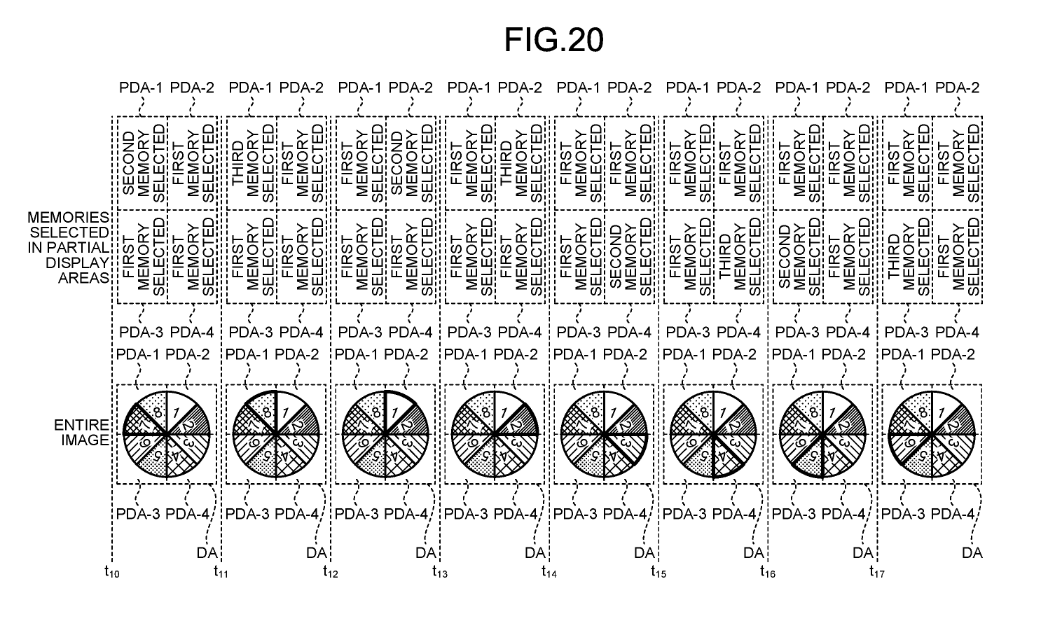

FIG. 19 is a timing diagram illustrating second operation timing of the display device according to the first embodiment. FIG. 20 is a diagram illustrating the entire image displayed in the second operation of the display device according to the first embodiment.

FIG. 19 is a timing diagram illustrating the operation timing of the display device 1 when the value REG is 3. When the value REG is 3, the controller 34b refers to the table TBL3 (refer to FIG. 10).

Also in the second operation example, one significant image is displayed in the display area DA. In other words, the sub-pixels SPix in the first to fourth partial display areas PDA-1 to PDA-4 cooperate to display one significant image.

At the initial time t₁₀, the counter value of the counter 34a is 0. Consequently, the controller 34b controls the first memory selection signal transmitter 33-1 such that the second memory 52 of each of the sub-pixels SPix in the first partial display area PDA-1 is selected. The controller 34b also controls the second to fourth memory selection signal transmitters 33-2 to 33-4 such that the first memory 51 of each of the sub-pixels SPix in the second to fourth partial display areas PDA-2 to PDA-4 is selected.

In order to select the second memory 52 of each of the sub-pixels SPix in the first partial display area PDA-1, the first memory selection signal transmitter 33-1 outputs the memory selection signal MSig to the 1_{b}th memory selection signal supply line L-1_{b}.

In order to select the first memory 51 of each of the sub-pixels SPix in the second to fourth partial display areas PDA-2 to PDA-4, the second to fourth memory selection signal transmitters 33-2 to 33-4 output the memory selection signal MSig to the 2ₐth to 4ₐth memory selection signal supply lines L-2, to L-4ₐ, respectively.

With this process, the display device 1 displays the entire image that is a combination of the 1_{b}th, 2ₐth, 3ₐth, and 4ₐth partial images at time t₁₀.

Referring to FIG. 20, at time t₁₀, the 1_{b}th, 2ₐth, 3ₐth, and 4ₐth partial images are displayed in the first to fourth partial display areas PDA-1 to PDA-4. This entire image is an image of a target including numbers from “1” to “8”. In the 1_{b}th partial image displayed in the first partial display area PDA-1, an image of “7” is highlighted with a border.

Referring again to FIG. 19, at the subsequent time t₁₁, the counter value of the counter 34a is 1. Consequently, the controller 34b controls the first memory selection signal transmitter 33-1 such that the third memory 53 of each of the sub-pixels SPix in the first partial display area PDA-1 is selected. The controller 34b also controls the second to fourth memory selection signal transmitters 33-2 to 33-4 such that the first memory 51 of each of the sub-pixels SPix in the second to fourth partial display areas PDA-2 to PDA-4 is selected.

In order to select the third memory 53 of each of the sub-pixels SPix in the first partial display area PDA-1, the first memory selection signal transmitter 33-1 outputs the memory selection signal MSig to the 1_{c}th memory selection signal supply line L-1_{c}.

In order to select the first memory 51 of each of the sub-pixels SPix in the second to fourth partial display areas PDA-2 to PDA-4, the second to fourth memory selection signal transmitters 33-2 to 33-4 output the memory selection signal MSig to the 2ₐth to 4ₐth memory selection signal supply lines L-2ₐ to L-4ₐ, respectively.

With this process, the display device 1 displays the entire image that is a combination of the 1_{c}th, 2ₐth, 3ₐth, and 4ₐth partial images at time t₁₁.

Referring to FIG. 20, at time t₁₁, the 1_{c}th, 2ₐth, 3ₐth, and 4ₐth partial images are displayed in the first to fourth partial display areas PDA-1 to PDA-4, respectively. In the 1_{c}th partial image displayed in the first partial display area PDA-1, an image of “8” is highlighted with a border.

Referring again to FIG. 19, at the subsequent time t₁₂, the counter value of the counter 34a is 2. Consequently, the controller 34b controls the first, third, and fourth memory selection signal transmitters 33-1, 33-3, and 33-4 such that the first memory 51 of each of the sub-pixels SPix in the first, third, and fourth partial display areas PDA-1, PDA-3, and PDA-4 is selected. The controller 34b also controls the second memory selection signal transmitter 33-2 such that the second memory 52 of each of the sub-pixels SPix in the second partial display area PDA-2 is selected.

In order to select the first memory 51 of each of the sub-pixels SPix in the first, third, and fourth partial display areas PDA-1, PDA-3, and PDA-4, the first, third, and fourth memory selection signal transmitters 33-1, 33-3, and 33-4 output the memory selection signal MSig to the 1ₐth, 3ₐth, and 4ₐth memory selection signal supply lines L-1ₐ, L-3ₐ, and L-4ₐ, respectively.

In order to select the second memory 52 of each of the sub-pixels SPix in the second partial display area PDA-2, the second memory selection signal transmitter 33-2 outputs the memory selection signal MSig to the 2_{b}th memory selection signal supply line L-2_{b}.

With this process, the display device 1 displays the entire image that is a combination of the 1ₐth, 2_{b}th, 3ₐth, and 4ₐth partial images at time t₁₂.

Referring to FIG. 20, at time t₁₂, the 1ₐth, 2_{b}th, 3ₐth, and 4ₐth partial images are displayed in the first to fourth partial display areas PDA-1 to PDA-4, respectively. In the 2_{b}th partial image displayed in the second partial display area PDA-2, an image of “1” is highlighted with a border.

Referring again to FIG. 19, at the subsequent time t₁₃, the counter value of the counter 34a is 3. Consequently, the controller 34b controls the first, third, and fourth memory selection signal transmitters 33-1, 33-3, and 33-4 such that the first memory 51 of each of the sub-pixels SPix in the first, third, and fourth partial display areas PDA-1, PDA-3, and PDA-4 is selected. The controller 34b also controls the second memory selection signal transmitter 33-2 such that the third memory 53 of each of the sub-pixels SPix in the second partial display area PDA-2 is selected.

In order to select the first memory 51 of each of the sub-pixels SPix in the first, third, and fourth partial display areas PDA-1, PDA-3, and PDA-4, the first, third, and fourth memory selection signal transmitters 33-1, 33-3, and 33-4 output the memory selection signal MSig to the 1ₐth, 3ₐth, and 4ₐth memory selection signal supply lines L-1ₐ, L-3ₐ, and L-4ₐ, respectively.

In order to select the third memory 53 of each of the sub-pixels SPix in the second partial display area PDA-2, the second memory selection signal transmitter 33-2 outputs the memory selection signal MSig to the 2_{c}th memory selection signal supply line L-2_{c}.

With this process, the display device 1 displays the entire image that is a combination of the 1ₐth, 2_{c}th, 3ₐth, and 4ₐth partial images at time t₁₃.

Referring to FIG. 20, at time t₁₃, the 1ₐth, 2_{c}th, 3ₐth, and 4ₐth partial images are displayed in the first to fourth partial display areas PDA-1 to PDA-4, respectively. In the 2_{c}th partial image displayed in the second partial display area PDA-2, an image of “2” is highlighted with a border.

Referring again to FIG. 19, at the subsequent time t₁₄, the counter value of the counter 34a is 4. Consequently, the controller 34b controls the first to third memory selection signal transmitters 33-1 to 33-3 such that the first memory 51 of each of the sub-pixels SPix in the first to third partial display areas PDA-1 to PDA-3 is selected. The controller 34b also controls the fourth memory selection signal transmitter 33-4 such that the second memory 52 of each of the sub-pixels SPix in the fourth partial display area PDA-4 is selected.

In order to select the first memory 51 of each of the sub-pixels SPix in the first to third partial display areas PDA-1 to PDA-3, the first to third memory selection signal transmitters 33-1 to 33-3 output the memory selection signal MSig to the 1ₐth to 3ₐth memory selection signal supply lines L-1ₐ to L-3ₐ, respectively.

In order to select the second memory 52 of each of the sub-pixels SPix in the fourth partial display area PDA-4, the fourth memory selection signal transmitter 33-4 outputs the memory selection signal MSig to the 4_{b}th memory selection signal supply line L-4_{b}.

With this process, the display device 1 displays the entire image that is a combination of the 1ₐth, 2ₐth, 3ₐth, and 4_{b}th partial images at time t₁₄.

Referring to FIG. 20, at time t₁₄, the 1ₐth, 2ₐth, 3ₐth, and 4_{b}th partial images are displayed in the first to fourth partial display areas PDA-1 to PDA-4, respectively. In the 4_{b}th partial image displayed in the fourth partial display area PDA-4, an image of “3” is highlighted with a border.

Referring again to FIG. 19, at the subsequent time t₁₅, the counter value of the counter 34a is 5. Consequently, the controller 34b controls the first to third memory selection signal transmitters 33-1 to 33-3 such that the first memory 51 of each of the sub-pixels SPix in the first to third partial display areas PDA-1 to PDA-3 is selected. The controller 34b also controls the fourth memory selection signal transmitter 33-4 such that the third memory 53 of each of the sub-pixels SPix in the fourth partial display area PDA-4 is selected.

In order to select the first memory 51 of each of the sub-pixels SPix in the first to third partial display areas PDA-1 to PDA-3, the first to third memory selection signal transmitters 33-1 to 33-3 output the memory selection signal MSig to the 1ₐth to 3ₐth memory selection signal supply lines L-1ₐ to L-3ₐ, respectively.

In order to select the third memory 53 of each of the sub-pixels SPix in the fourth partial display area PDA-4, the fourth memory selection signal transmitter 33-4 outputs the memory selection signal MSig to the 4_{c}th memory selection signal supply line L-4_{c}.

With this process, the display device 1 displays the entire image that is a combination of the 1ₐth, 2ₐth, 3ₐth, and 4_{c}th partial images at time t₁₅.

Referring to FIG. 20, at time t₁₅, the 1ₐth, 2ₐth, 3ₐth, and 4_{c}th partial images are displayed in the first to fourth partial display areas PDA-1 to PDA-4, respectively. In the 4_{c}th partial image displayed in the fourth partial display area PDA-4, an image of “4” is highlighted with a border.

Referring again to FIG. 19, at the subsequent time t₁₆, the counter value of the counter 34a is 6. Consequently, the controller 34b controls the first, second, and fourth memory selection signal transmitters 33-1, 33-2, and 33-4 such that the first memory 51 of each of the sub-pixels SPix in the first, second, and fourth partial display areas PDA-1, PDA-2, and PDA-4 is selected. The controller 34b also controls the third memory selection signal transmitter 33-3 such that the second memory 52 of each of the sub-pixels SPix in the third partial display area PDA-3 is selected.

In order to select the first memory 51 of each of the sub-pixels SPix in the first, second, and fourth partial display areas PDA-1, PDA-2, and PDA-4, the first, second, and fourth memory selection signal transmitters 33-1, 33-2, and 33-4 output the memory selection signal MSig to the 1ₐth, 2ₐth, and 4ₐth memory selection signal supply lines L-1ₐ, L-2ₐ, and L-4ₐ, respectively.

In order to select the second memory 52 of each of the sub-pixels SPix in the third partial display area PDA-3, the third memory selection signal transmitter 33-3 outputs the memory selection signal MSig to the 3_{b}th memory selection signal supply line L-3_{b}.

With this process, the display device 1 displays the entire image that is a combination of the 1ₐth, 2ₐth, 3_{b}th, and 4ₐth partial images at time t₁₆.

Referring to FIG. 20, at time t₁₆, the 1ₐth, 2ₐth, 3_{b}th, and 4ₐth partial images are displayed in the first to fourth partial display areas PDA-1 to PDA-4, respectively. In the 3_{b}th partial image displayed in the third partial display area PDA-3, an image of “5” is highlighted with a border.

Referring again to FIG. 19, at the subsequent time t₁₇, the counter value of the counter 34a is 7. Consequently, the controller 34b controls the first, second, and fourth memory selection signal transmitters 33-1, 33-2, and 33-4 such that the first memory 51 of each of the sub-pixels SPix in the first, second, and fourth partial display areas PDA-1, PDA-2, and PDA-4 is selected. The controller 34b also controls the third memory selection signal transmitter 33-3 such that the third memory 53 of each of the sub-pixels SPix in the third partial display area PDA-3 is selected.

In order to select the first memory 51 of each of the sub-pixels SPix in the first, second, and fourth partial display areas PDA-1, PDA-2, and PDA-4, the first, second, and fourth memory selection signal transmitters 33-1, 33-2, and 33-4 output the memory selection signal MSig to the 1ₐth, 2ₐth, and 4ₐth memory selection signal supply lines L-1ₐ, L-2ₐ, and L-4ₐ, respectively.

In order to select the third memory 53 of each of the sub-pixels SPix in the third partial display area PDA-3, the third memory selection signal transmitter 33-3 outputs the memory selection signal MSig to the 3_{c}th memory selection signal supply line L-3_{c}.

With this process, the display device 1 displays the entire image that is a combination of the 1ₐth, 2ₐth, 3_{c}th, and 4ₐth partial images at time t₁₇.

Referring to FIG. 20, at time t₁₇, the 1ₐth, 2ₐth, 3_{c}th, and 4ₐth partial images are displayed in the first to fourth partial display areas PDA-1 to PDA-4, respectively. In the 3_{c}th partial image displayed in the third partial display area PDA-3, an image of “6” is highlighted with a border.

In the display device 1 of the first embodiment, the memory selection circuit 33 handles each of the first to fourth partial display areas PDA-1 to PDA-4 as the selection unit. The memory selection circuit 33 simultaneously selects, in one selection unit at a time, one of the first to third memories 51 to 53 in each of the sub-pixels SPix in that selection unit. Consequently, the display device 1 can change the entire image in a short period of time by switching the selection of the first to third memories 51 to 53 of each of the sub-pixels SPix in the first to fourth partial display areas PDA-1 to PDA-4. The display device 1 can also perform the animation display (moving image display) by sequentially switching the selection of the first to third memories 51 to 53 of each of the sub-pixels SPix in the first to fourth partial display areas PDA-1 to PDA-4.

In the display device 1 of the first embodiment, the memory selection circuit 33 simultaneously selects, in one selection unit at a time, one of the first to third memories 51 to 53 in each of the sub-pixels SPix in that selection unit. Consequently, although each of the sub-pixels SPix has only three memories, i.e., the first to third memories 51 to 53, the display device 1 can display four or more different entire images. As a result, the display device 1 can perform a smooth animation display.

In the display device 1 of the first embodiment, when the sub-pixels included in the partial display area PDA display a partial display image that does not change, then the memory selection circuit 33 does not switch between the memories in each sub-pixel in that partial display area PDA.

This configuration allows the display device 1 to reduce the power consumption when the entire image changes.

### Application Example of First Embodiment

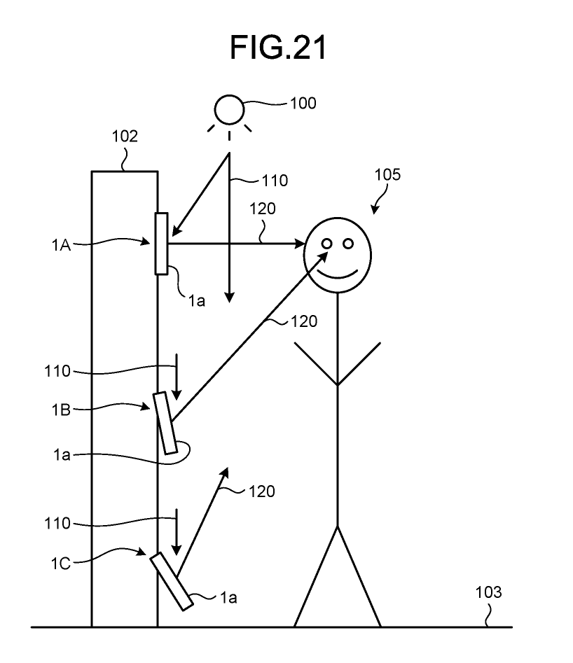

FIG. 21 is a diagram illustrating an application example of the display device according to the first embodiment. FIG. 21 is a diagram illustrating an example in which the display device 1 is applied to electronic shelf labels.

As illustrated in FIG. 21, display devices 1A, 1B, and 1C are mounted on shelving 102. Each of the display devices 1A, 1B, and 1C has the same configuration as that of the display device 1 described above. The display devices 1A, 1B, and 1C are located at different heights from a floor surface 103, and they are set up so as to have different panel inclination angles. The panel inclination angle is an angle formed between the normal line to the display surface 1a and the horizontal direction. The display devices 1A, 1B, and 1C reflect incident light 110 from a lighting device 100 serving as a light source to output an image 120 toward a viewer 105.

### First Modification

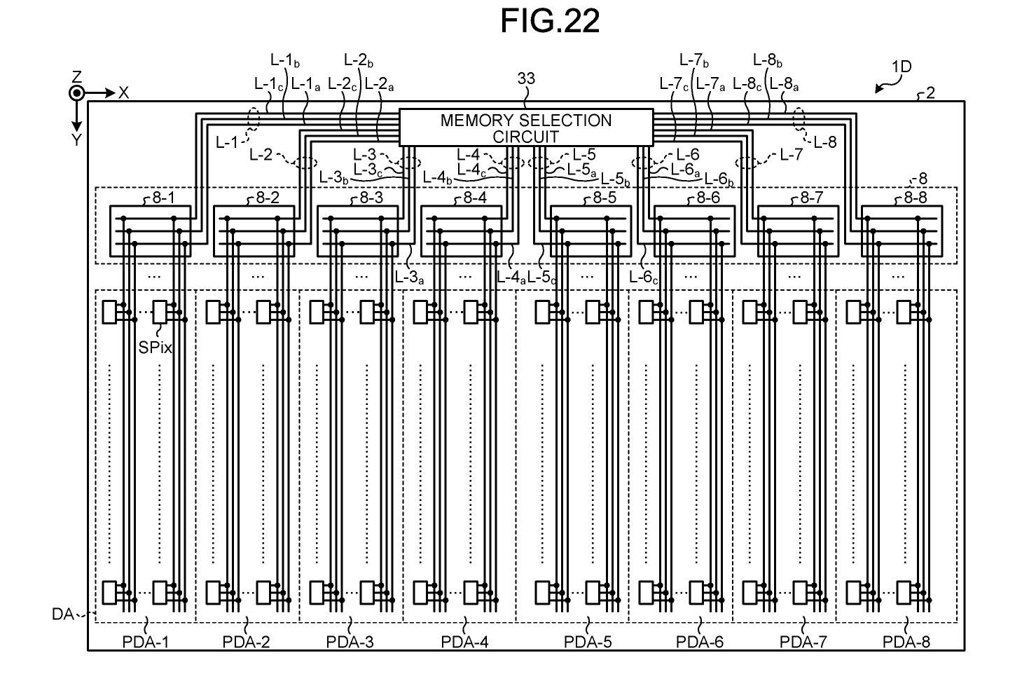

FIG. 22 is a diagram illustrating a coupling relation between the memory selection circuit, the distribution circuit, and the sub-pixels of a display device according to a first modification of the first embodiment.

The display area DA of a display device 1D includes first to eighth partial display areas PDA-1 to PDA-8. The first to eighth partial display areas PDA-1 to PDA-8 are arranged in the X-direction.

In each of the first to eighth partial display areas PDA-1 to PDA-8, the pixels Pix are disposed in a matrix of N columns (where N is a natural number) arranged in the X-direction and M rows (where M is a natural number) arranged in the Y-direction. Accordingly, the pixels Pix are disposed in a matrix of (N×8) columns arranged in the X-direction and M rows arranged in the Y-direction in the display area DA.

In the first modification of the first embodiment, three memory selection lines are arranged for each column in each of the first to eighth partial display areas PDA-1 to PDA-8. Accordingly, (N×3×8) memory selection lines are arranged in the display area DA.

The memory selection signal distribution circuit 8 of the display device 1D includes first to eighth distribution circuits 8-1 to 8-8. The memory selection circuit 33 is coupled to the first to eighth distribution circuits 8-1 to 8-8 through first to eighth memory selection signal supply line groups L-1 to L-8.

One end of each of the three memory selection lines of each column in the first partial display area PDA-1 is coupled to the first distribution circuit 8-1. One end of each of the three memory selection lines of each column in the second partial display area PDA-2 is coupled to the second distribution circuit 8-2. One end of each of the three memory selection lines of each column in the third partial display area PDA-3 is coupled to the third distribution circuit 8-3. One end of each of the three memory selection lines of each column in the fourth partial display area PDA-4 is coupled to the fourth distribution circuit 8-4. One end of each of the three memory selection lines of each column in the fifth partial display area PDA-5 is coupled to the fifth distribution circuit 8-5. One end of each of the three memory selection lines of each column in the sixth partial display area PDA-6 is coupled to the sixth distribution circuit 8-6. One end of each of the three memory selection lines of each column in the seventh partial display area PDA-7 is coupled to the seventh distribution circuit 8-7. One end of each of the three memory selection lines of each column in the eighth partial display area PDA-8 is coupled to the eighth distribution circuit 8-8. The three memory selection lines of each column in the first partial display area PDA-1 are electrically coupled to the first to third memories 51 to 53 of each of M sub-pixels SPix included in the column in the first partial display area PDA-1, respectively. The three memory selection lines of each column in the second partial display area PDA-2 are electrically coupled to the first to third memories 51 to 53 of each of M sub-pixels SPix included in the column in the second partial display area PDA-2, respectively. The three memory selection lines of each column in the third partial display area PDA-3 are electrically coupled to the first to third memories 51 to 53 of each of M sub-pixels SPix included in the column in the third partial display area PDA-3, respectively. The three memory selection lines of each column in the fourth partial display area PDA-4 are electrically coupled to the first to third memories 51 to 53 of each of M sub-pixels SPix included in the column in the fourth partial display area PDA-4, respectively. The three memory selection lines of each column in the fifth partial display area PDA-5 are electrically coupled to the first to third memories 51 to 53 of each of M sub-pixels SPix included in the column in the fifth partial display area PDA-5, respectively. The three memory selection lines of each column in the sixth partial display area PDA-6 are electrically coupled to the first to third memories 51 to 53 of each of M sub-pixels SPix included in the column in the sixth partial display area PDA-6, respectively. The three memory selection lines of each column in the seventh partial display area PDA-7 are electrically coupled to the first to third memories 51 to 53 of each of M sub-pixels SPix included in the column in the seventh partial display area PDA-7, respectively. The three memory selection lines of each column in the eighth partial display area PDA-8 are electrically coupled to the first to third memories 51 to 53 of each of M sub-pixels SPix included in the column in the eighth partial display area PDA-8, respectively.

The first memory selection signal supply line group L-1 includes the 1ₐth to 1ₐth memory selection signal supply lines L-1, to L-1_{c}. The second memory selection signal supply line group L-2 includes the 2ₐth to 2_{c}th memory selection signal supply lines L-2, to L-2_{c}. The third memory selection signal supply line group L-3 includes the 3ₐth to 3_{c}th memory selection signal supply lines L-3, to L-3_{c}. The fourth memory selection signal supply line group L-4 includes the 4ₐth to 4_{c}th memory selection signal supply lines L-4, to L-4_{c}. The fifth memory selection signal supply line group L-5 includes 5ₐth to 5_{c}th memory selection signal supply lines L-5, to L-5ₐ. The sixth memory selection signal supply line group L-6 includes 6ₐth to 6ₐth memory selection signal supply lines L-6, to L-6ₐ. The seventh memory selection signal supply line group L-7 includes 1ₐth to 1ₐth memory selection signal supply lines L-7, to L-7ₐ. The eighth memory selection signal supply line group L-8 includes 8ₐth to 8ₐth memory selection signal supply lines L-8, to L-8_{c}.

Under the control of the controller 34b (refer to FIG. 7), the memory selection circuit 33 outputs the memory selection signal MSig to one of the 1ₐth to 1ₐth memory selection signal supply lines L-1, to L-1ₐ. Under the control of the controller 34b, the memory selection circuit 33 outputs the memory selection signal MSig to one of the 2ₐth to 2ₐth memory selection signal supply lines L-2, to L-2_{c}. Under the control of the controller 34b, the memory selection circuit 33 outputs the memory selection signal MSig to one of the 3ₐth to 3ₐth memory selection signal supply lines L-3, to L-3_{c}.

Under the control of the controller 34b, the memory selection circuit 33 outputs the memory selection signal MSig to one of the 4ₐth to 4ₐth memory selection signal supply lines L-4, to L-4ₐ. Under the control of the controller 34b, the memory selection circuit 33 outputs the memory selection signal MSig to one of the 5ₐth to 5_{c}th memory selection signal supply lines L-5, to L-5_{c}. Under the control of the controller 34b, the memory selection circuit 33 outputs the memory selection signal MSig to one of the 6ₐth to 6_{c}th memory selection signal supply lines L-6ₐ to L-6_{c}.

Under the control of the controller 34b, the memory selection circuit 33 outputs the memory selection signal MSig to one of the 1ₐth to 7_{c}th memory selection signal supply lines L-7, to L-7_{c}. Under the control of the controller 34b, the memory selection circuit 33 outputs the memory selection signal MSig to one of the 8ₐth to 8_{c}th memory selection signal supply lines L-8, to L-8_{c}.

The first to eighth distribution circuits 8-1 to 8-8 output the memory selection signal MSig supplied from the memory selection circuit 33 to each of the sub-pixels SPix in the first to eighth partial display areas PDA-1 to PDA-8, respectively.

The memory selection circuit 33 handles each of the first to eighth partial display areas PDA-1 to PDA-8 as the selection unit. The memory selection circuit 33 simultaneously selects, in one selection unit at a time, one of the first to third memories in each of the sub-pixels SPix in that selection unit.

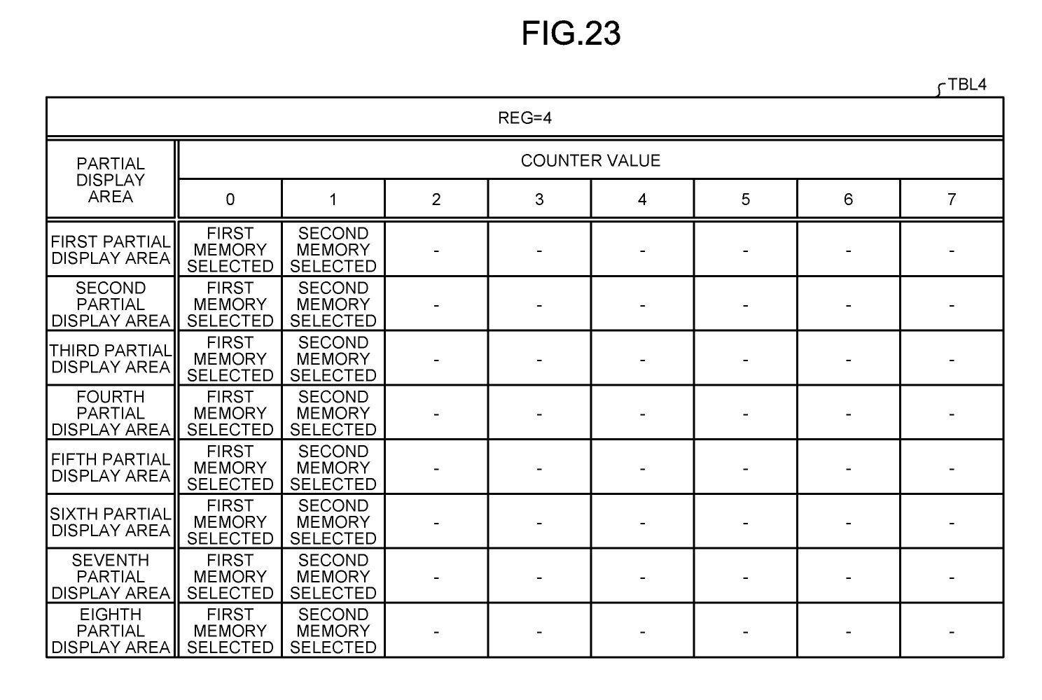

FIG. 23 is a diagram illustrating an example of a table stored in the storage of the display device according to the first modification of the first embodiment.

When the value REG is 4, the controller 34b (refer to FIG. 7) refers to a table TBL4 illustrated in FIG. 23. When the value REG is 4, the controller 34b causes the counter 34a (refer to FIG. 7) to operate as a binary counter. Consequently, the counter 34a counts 0, 1, 0 . . . in synchronization with the selected clock signal CLK-SEL.

When the counter value is 0, the controller 34b controls the memory selection circuit 33 such that the first memory 51 of each of the sub-pixels SPix in the first to eighth partial display areas PDA-1 to PDA-8 is selected. In order to select the first memory 51 of each of the sub-pixels SPix in the first to eighth partial display areas PDA-1 to PDA-8, the memory selection circuit 33 outputs the memory selection signal MSig to the 1ₐth to 8ₐth memory selection signal supply lines L-1, to L-8ₐ.

When the counter value is 1, the controller 34b controls the memory selection circuit 33 such that the second memory 52 of each of the sub-pixels SPix in the first to eighth partial display areas PDA-1 to PDA-8 is selected. In order to select the second memory 52 of each of the sub-pixels SPix in the first to eighth partial display areas PDA-1 to PDA-8, the memory selection circuit 33 outputs the memory selection signal MSig to the 1_{b}th to 8_{b}th memory selection signal supply lines L-1_{b} to L-8_{b}.

### Operation Example of First Modification

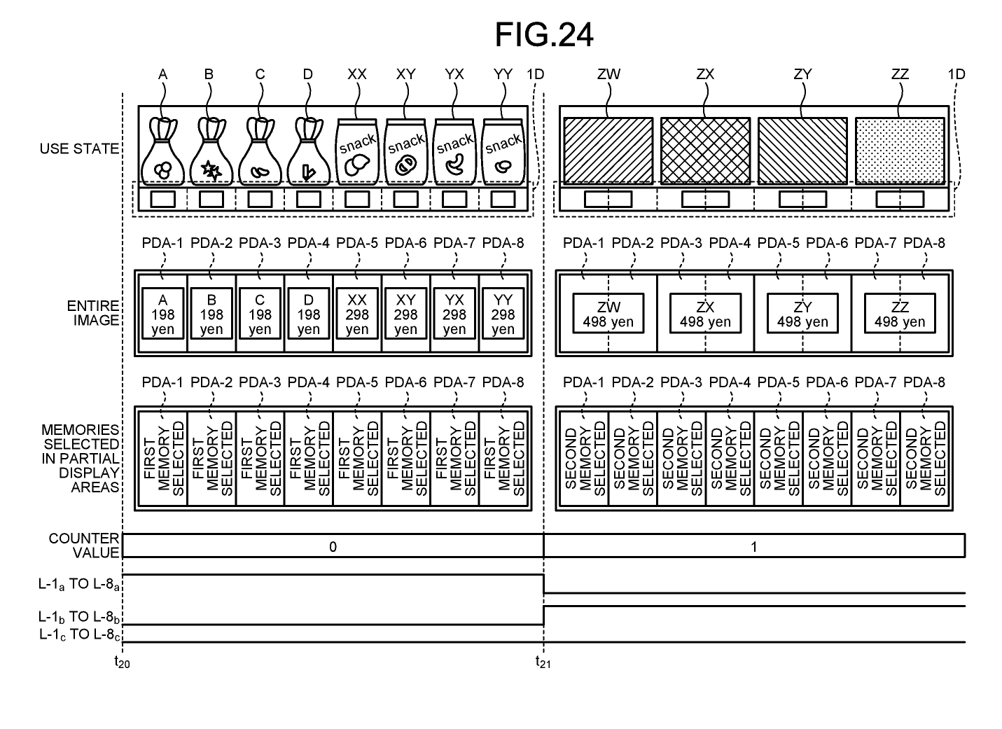

FIG. 24 is a diagram illustrating an operation of the display device according to the first modification of the first embodiment. In the operation example of the first modification, the display device 1D is used for the electronic shelf labels.

In the first modification, at a first time, eight significant images are displayed in the display area DA. In other words, the sub-pixels SPix in the first to eighth partial display areas PDA-1 to PDA-8 display the eight significant images.

At a second time, four significant images are displayed in the display area DA. In other words, the sub-pixels SPix in the first and second partial display areas PDA-1 and PDA-2 cooperate to display one significant image. In the same manner, the sub-pixels SPix in the third and fourth partial display areas PDA-3 and PDA-4 cooperate to display one significant image. In the same manner, the sub-pixels SPix in the fifth and sixth partial display areas PDA-5 and PDA-6 cooperate to display one significant image. In the same manner, the sub-pixels SPix in the seventh and eighth partial display areas PDA-7 and PDA-8 cooperate to display one significant image.

FIG. 24 is a timing diagram illustrating the operation timing of the display device 1D when the value REG is 4. When the value REG is 4, the controller 34b refers to the table TBL4 (refer to FIG. 23).

At the initial time t₂₀, the counter value of the counter 34a is 0. Consequently, the controller 34b controls first to eighth memory selection signal transmitters 33-1 to 33-8 such that the first memory 51 of each of the sub-pixels SPix in the first to eighth partial display areas PDA-1 to PDA-8 is selected.

In order to select the first memory 51 of each of the sub-pixels SPix in the first to eighth partial display areas PDA-1 to PDA-8, the first to eighth memory selection signal transmitters 33-1 to 33-8 output the memory selection signal MSig to the 1ₐth to 8ₐth memory selection signal supply lines L-1ₐ to L-8ₐ, respectively.

With this process, the eight significant images are respectively displayed in the first to eighth partial display areas PDA-1 to PDA-8 at time t₂₀.

At time t₂₀, eight products A, B, C, D, XX, XY, YX, and YY are displayed on a shelf where the display device 1D is mounted. Prices of the respective products are displayed in the first to eighth partial display areas PDA-1 to PDA-8.

The price of the product A is displayed as “A 198 yen” in the first partial display area PDA-1. The price of the product B is displayed as “B 198 yen” in the second partial display area PDA-2. The price of the product C is displayed as “C 198 yen” in the third partial display area PDA-3. The price of the product D is displayed as “D 198 yen” in the fourth partial display area PDA-4.

The price of the product XX is displayed as “XX 298 yen” in the fifth partial display area PDA-5. The price of the product XY is displayed as “XY 298 yen” in the sixth partial display area PDA-6. The price of the product YX is displayed as “YX 298 yen” in the seventh partial display area PDA-7. The price of the product YY is displayed as “YY 298 yen” in the eighth partial display area PDA-8.

At the subsequent time t₂₁, the counter value of the counter 34a is 1. Consequently, the controller 34b controls the first to eighth memory selection signal transmitters 33-1 to 33-8 such that the second memory 52 of each of the sub-pixels SPix in the first to eighth partial display areas PDA-1 to PDA-8 is selected.

In order to select the second memory 52 of each of the sub-pixels SPix in the first to eighth partial display areas PDA-1 to PDA-8, the first to eighth memory selection signal transmitters 33-1 to 33-8 output the memory selection signal MSig to the 1_{b}th to 8_{b}th memory selection signal supply lines L-1_{b} to L-8_{b}, respectively.

With this process, four significant images are displayed in the first to eighth partial display areas PDA-1 to PDA-8 at time t₂₁.

At time t₂₁, four products ZW, ZX, ZY, and ZZ are displayed on the shelf where the display device 1D is mounted. Prices of the respective products are displayed in the first to eighth partial display areas PDA-1 to PDA-8.

The price of the product ZW is displayed as “ZW 498 yen” in the first and second partial display areas PDA-1 and PDA-2. The price of the product ZX is displayed as “ZX 498 yen” in the third and fourth partial display areas PDA-3 and PDA-4. The price of the product ZY is displayed as “ZY 498 yen” in the fifth and sixth partial display areas PDA-5 and PDA-6. The price of the product ZZ is displayed as “ZZ 498 yen” in the seventh and eighth partial display areas PDA-7 and PDA-8.

In the display device 1D according to the first modification of the first embodiment, the eight significant images are displayed in the display area DA at the first time. In other words, the sub-pixels SPix in the first to eighth partial display areas PDA-1 to PDA-8 display the eight significant images.

In the display device 1D according to the first modification of the first embodiment, the four significant images are displayed in the display area DA at the second time. In other words, the sub-pixels SPix in the first and second partial display areas PDA-1 and PDA-2 operate together to display one significant image. In the same manner, the sub-pixels SPix in the third and fourth partial display areas PDA-3 and PDA-4 cooperate to display one significant image. In the same manner, the sub-pixels SPix in the fifth and sixth partial display areas PDA-5 and PDA-6 cooperate to display one significant image. In the same manner, the sub-pixels SPix in the seventh and eighth partial display areas PDA-7 and PDA-8 cooperate to display one significant image.

With this process, the display device 1D according to the first modification of the first embodiment can change the number of displayed significant images in accordance with the use state. This configuration is particularly effective when the display device 1D according to the first modification of the first embodiment is used for the electronic shelf labels.

### Second Modification

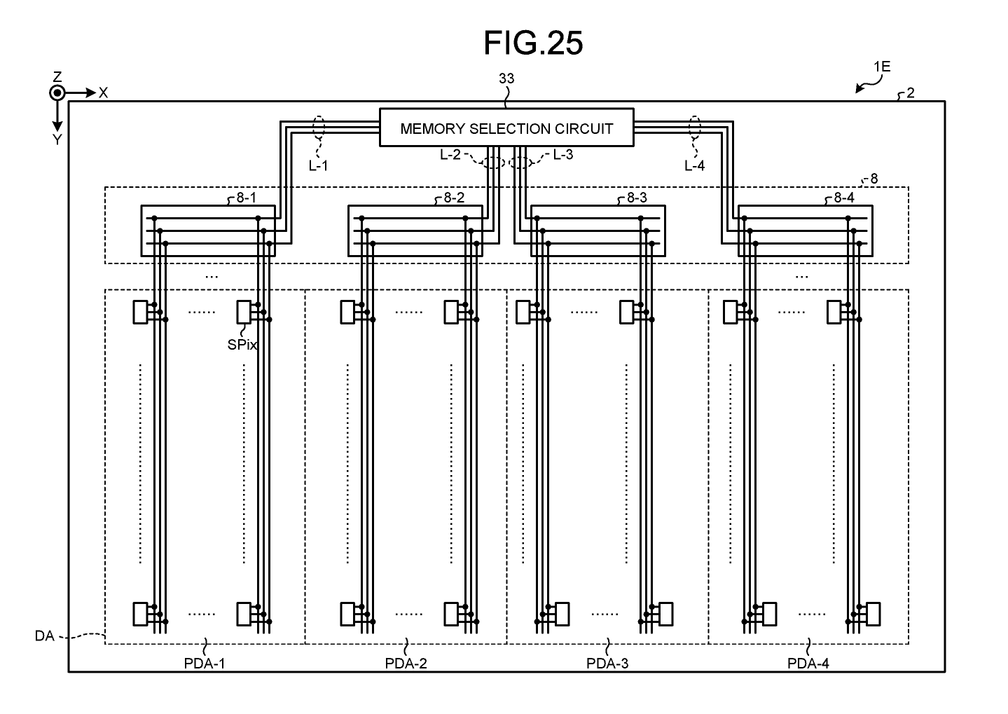

FIG. 25 is a diagram illustrating a coupling relation between the memory selection circuit, the distribution circuit, and the sub-pixels of a display device according to a second modification of the first embodiment.

The display area DA of a display device 1E includes the first to fourth partial display areas PDA-1 to PDA-4. The first to fourth partial display areas PDA-1 to PDA-4 are arranged in the X-direction.

The memory selection signal distribution circuit 8 of the display device 1E includes the first to fourth distribution circuits 8-1 to 8-4. The memory selection circuit 33 is coupled to the first to fourth distribution circuits 8-1 to 8-4 through the first to fourth memory selection signal supply line groups L-1 to L-4.

One end of each of the three memory selection lines of each column in the first partial display area PDA-1 is coupled to the first distribution circuit 8-1. One end of each of the three memory selection lines of each column in the second partial display area PDA-2 is coupled to the second distribution circuit 8-2. One end of each of the three memory selection lines of each column in the third partial display area PDA-3 is coupled to the third distribution circuit 8-3. One end of each of the three memory selection lines of each column in the fourth partial display area PDA-4 is coupled to the fourth distribution circuit 8-4. The three memory selection lines of each column in the first partial display area PDA-1 are electrically coupled to the first to third memories 51 to 53 of each of the sub-pixels SPix included in the column in the first partial display area PDA-1, respectively. The three memory selection lines of each column in the second partial display areas PDA-2 are electrically coupled to the first to third memories 51 to 53 of each of the sub-pixels SPix included in the column in the second partial display area PDA-2, respectively. The three memory selection lines of each column in the third partial display area PDA-3 are electrically coupled to the first to third memories 51 to 53 of each of the sub-pixels SPix included in the column in the third partial display area PDA-3, respectively. The three memory selection lines of each column in the fourth partial display area PDA-4 are electrically coupled to the first to third memories 51 to 53 of each of the sub-pixels SPix included in the column in the fourth partial display area PDA-4, respectively.

The operation of the display device 1E according to the second modification of the first embodiment is the same as that described above, and is therefore neither illustrated nor described.

### Third Modification

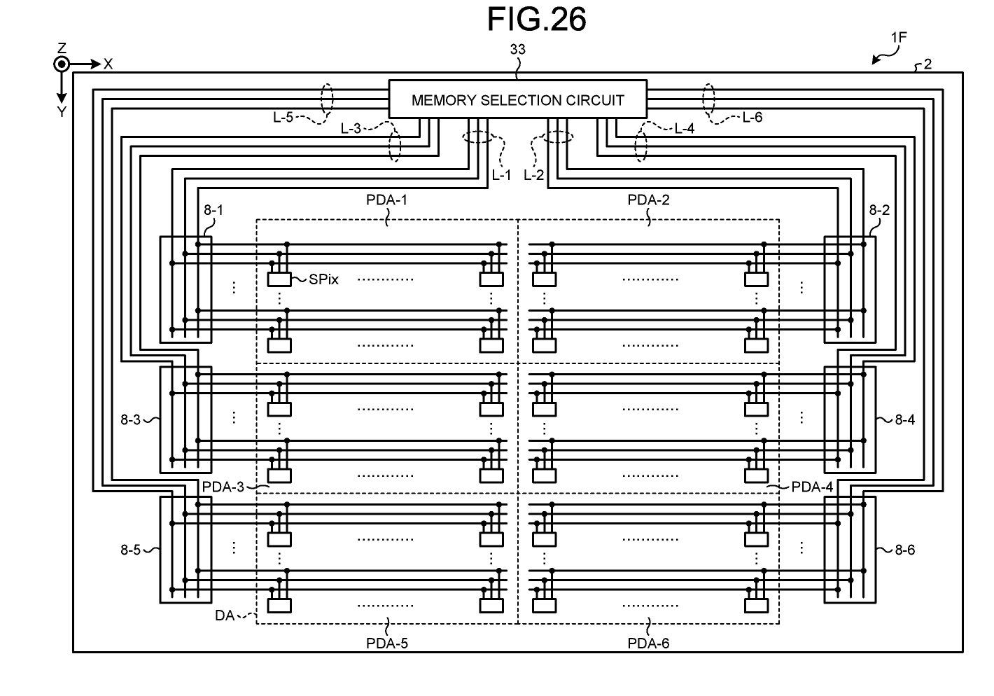

FIG. 26 is a diagram illustrating a coupling relation between the memory selection circuit, the distribution circuit, and the sub-pixels of a display device according to a third modification of the first embodiment.

The display area DA of a display device 1F includes the first to sixth partial display areas PDA-1 to PDA-6. The second partial display area PDA-2 is adjacent to the first partial display area PDA-1 in the X-direction. The third partial display area PDA-3 is adjacent to the first partial display area PDA-1 in the Y-direction. The fourth partial display area PDA-4 is adjacent to the second partial display area PDA-2 in the Y-direction and is adjacent to the third partial display area PDA-3 in the X-direction. The fifth partial display area PDA-5 is adjacent to the third partial display area PDA-3 in the Y-direction. The sixth partial display area PDA-6 is adjacent to the fourth partial display area PDA-4 in the Y-direction and is adjacent to the fifth partial display area PDA-5 in the X-direction.

One end of each of the three memory selection lines of each column in the first partial display area PDA-1 is coupled to the first distribution circuit 8-1. One end of each of the three memory selection lines of each column in the second partial display area PDA-2 is coupled to the second distribution circuit 8-2. One end of each of the three memory selection lines of each column in the third partial display area PDA-3 is coupled to the third distribution circuit 8-3. One end of each of the three memory selection lines of each column in the fourth partial display area PDA-4 is coupled to the fourth distribution circuit 8-4. One end of each of the three memory selection lines of each column in the fifth partial display area PDA-5 is coupled to the fifth distribution circuit 8-5. One end of each of the three memory selection lines of each column in the sixth partial display area PDA-6 is coupled to the sixth distribution circuit 8-6. The three memory selection lines of each column in the first partial display area PDA-1 are electrically coupled to the first to third memories 51 to 53 of each of the sub-pixels SPix included in the column in the first partial display area PDA-1, respectively. The three memory selection lines of each column in the second partial display area PDA-2 are electrically coupled to the second memories 51 to 53 of each of the sub-pixels SPix included in the column in the second partial display area PDA-2, respectively. The three memory selection lines of each column in the third partial display area PDA-3 are electrically coupled to the first to third memories 51 to 53 of each of the sub-pixels SPix included in the column in the third partial display area PDA-3, respectively. The three memory selection lines of each column in the fourth partial display area PDA-4 are electrically coupled to the first to third memories 51 to 53 of each of the sub-pixels SPix included in the column in the fourth partial display area PDA-4, respectively. The three memory selection lines of each column in the fifth partial display area PDA-5 are electrically coupled to the first to third memories 51 to 53 of each of the sub-pixels SPix included in the column in the fifth partial display area PDA-5, respectively. The three memory selection lines of each column in the sixth partial display area PDA-6 are electrically coupled to the first to third memories 51 to 53 of each of the sub-pixels SPix included in the column in the sixth partial display area PDA-6, respectively.

The operation of the display device 1F according to the third modification of the first embodiment is the same as that described above, and is therefore neither illustrated nor described.

### Fourth Modification

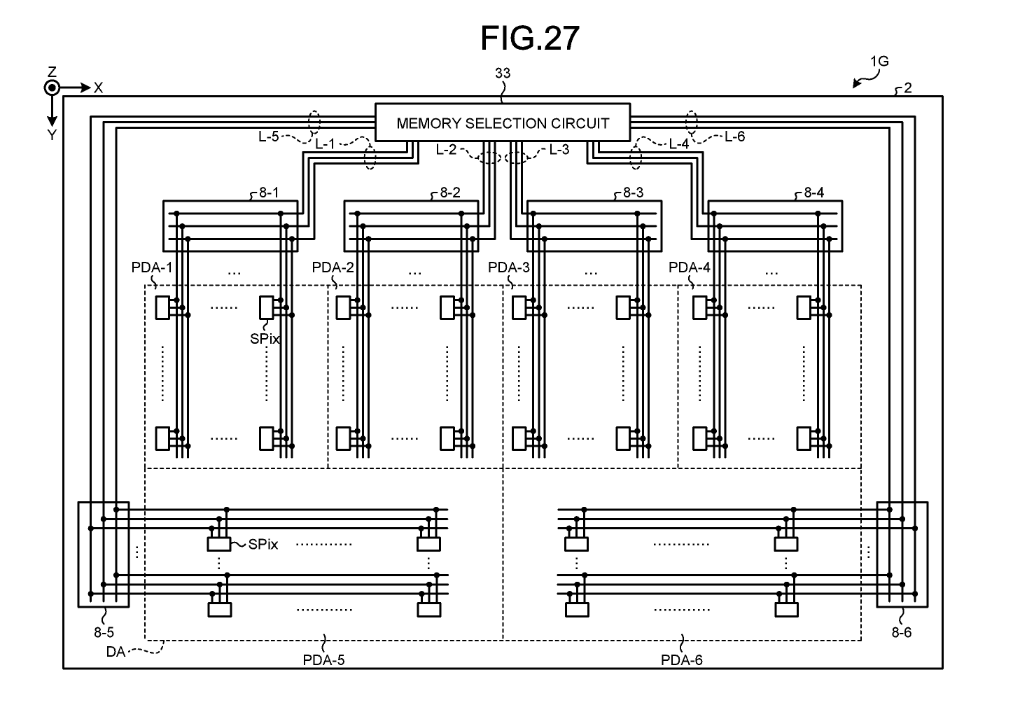

FIG. 27 is a diagram illustrating a coupling relation between the memory selection circuit, the distribution circuit, and the sub-pixels of a display device according to a fourth modification of the first embodiment.

The display area DA of a display device 1G includes the first to sixth partial display areas PDA-1 to PDA-6. The first to fourth partial display areas PDA-1 to PDA-4 are arranged in the X-direction. The fifth partial display area PDA-5 is adjacent to the first and second partial display areas PDA-1 and PDA-2 in the Y-direction. The sixth partial display area PDA-6 is adjacent to the third and fourth partial display areas PDA-3 and PDA-4 in the Y-direction and is adjacent to the fifth partial display area PDA-5 in the X-direction.

One end of each of the three memory selection lines of each column in the first partial display area PDA-1 is coupled to the first distribution circuit 8-1. One end of each of the three memory selection lines of each column in the second partial display area PDA-2 is coupled to the second distribution circuit 8-2. One end of each of the three memory selection lines of each column in the third partial display area PDA-3 is coupled to the third distribution circuit 8-3. One end of each of the three memory selection lines of each column in the fourth partial display area PDA-4 is coupled to the fourth distribution circuit 8-4. The three memory selection lines of each column in the first partial display area PDA-1 are electrically coupled to the first to third memories 51 to 53 of each of the sub-pixels SPix included in the column in the first partial display area PDA-1, respectively. The three memory selection lines of each column in the second partial display area PDA-2 are electrically coupled to the first to third memories 51 to 53 of each of the sub-pixels SPix included in the column in the second partial display area PDA-2, respectively. The three memory selection lines of each column in the third partial display area PDA-3 are electrically coupled to the first to third memories 51 to 53 of each of the sub-pixels SPix included in the column in the third partial display area PDA-3, respectively. The three memory selection lines of each column in the fourth partial display area PDA-4 are electrically coupled to the first to third memories 51 to 53 of each of the sub-pixels SPix included in the column in the fourth partial display area PDA-4, respectively.

One end of each of the three memory selection lines of each row in the fifth partial display area PDA-5 is coupled to the fifth distribution circuit 8-5. One end of each of the three memory selection lines of each row in the sixth partial display area PDA-6 is coupled to the sixth distribution circuit 8-6. The three memory selection lines of each row in the fifth partial display area PDA-5 are electrically coupled to the first to third memories 51 to 53 of each of the sub-pixels SPix included in each row in the fifth partial display area PDA-5, respectively. The three memory selection lines of each row in the sixth partial display area PDA-6 are electrically coupled to the first to third memories 51 to 53 of each of the sub-pixels SPix included in each row in the sixth partial display area PDA-6, respectively.

The operation of the display device 1G according to the fourth modification of the first embodiment is the same as that described above, and is therefore neither illustrated nor described.

The preferred embodiment of the present disclosure has been described above. The present disclosure is, however, not limited to the embodiment described above. The content disclosed in the embodiment is merely an example, and can be variously modified within the scope not departing from the gist of the present disclosure. Any modifications appropriately made within the scope not departing from the gist of the present disclosure also naturally belong to the technical scope of the present disclosure. At least one of various omissions, replacements, and modifications of the components can be made without departing from the gist of the embodiment and the modifications described above.

What is claimed is:

1. A display device comprising:
a display area including a plurality of partial display areas;
a plurality of sub-pixels arranged in a row direction and a column direction in each of the partial display areas, each of the sub-pixels comprising a memory block with a plurality of memories configured to store sub-pixel data;
a plurality of memory selection line groups, each of which is provided in each row or column in each of the partial display areas and comprises a plurality of memory selection lines, each of the memory selection lines electrically being coupled to the memory blocks, each of which belongs to the sub-pixels arranged in the row or the column;
a memory selection control circuit configured to select, based on a set value, one of the memory selection lines from each of the memory selection line groups, the memory selection lines selected functioning as an output destination of a memory selection signal for one of the memories in the memory block;
a memory selection circuit configured to output the memory selection signal based on the selection made by the memory selection control circuit; and
a plurality of distribution circuits coupled to the memory selection line groups and configured to output the memory selection signal, which is output from the memory selection circuit, to the selected one of the memory selection lines in each of the memory selection line groups.

2. The display device according to claim 1,
wherein the memory selection control circuit is configured to sequentially switch the memory selection line as the output destination of the memory selection signal in one or more of the partial display areas, based on the set value, and
wherein the sub-pixels in each of the partial display areas are configured to display a moving image in the display area by displaying, in a sequence that follows the sequential switching of the memory selection line serving as the output destination of the memory selection signal, a plurality of partial images, based on a plurality of pieces of the sub-pixel data stored in the respective memories.

3. The display device according to claim 1,
wherein the memory selection control circuit is configured to sequentially switch the memory selection line serving as the output destination of the memory selection signal in one or more of the partial display areas, based on the set value, and
wherein the sub-pixels in each of the partial display areas are configured to display a first number of significant images in the display area at a first time and display a second number of significant images in the display area at a second time by displaying, in a sequence that follows the sequential switching of the memory selection line as the output destination of the memory selection signal, a plurality of partial images, based on a plurality of pieces of the sub-pixel data stored in the respective memories, the second number being different from the first number.

4. The display device according to claim 1,
wherein the partial display areas are arranged in a matrix.

5. The display device according to claim 1,
wherein the partial display areas are arranged in one direction.

6. The display device according to claim 1,
wherein a third number of the partial display areas are arranged in one direction in one area, and
wherein a fourth number of the partial display areas are arranged in one direction in another area, the fourth number being different from the third number.

7. The display device according to claim 1,
wherein each of the sub-pixels further comprises:
a sub-pixel electrode; and
a switch circuit configured to output, to the sub-pixel electrode, the sub-pixel data output from the memory block,
wherein the display device further comprises:
a plurality of display signal lines that are provided for the rows and electrically coupled to the switch circuits; and
an inversion drive circuit configured to
invert, in synchronization with a clock signal, a display signal for leaving unchanged or inverting the sub-pixel data to be supplied to the sub-pixel electrode and
output the display signal to the display signal lines, and
wherein the switch circuit is configured to output the sub-pixel data left unchanged or in an inverted form to the sub-pixel electrode, based on the display signal.

8. The display device according to claim 1, further comprising:
a common electrode provided with a common potential that is common to the sub pixels;
a common electrode drive circuit coupled to the common electrode and configured to provide the common potential to the common electrode; and
a first display signal line and a second display signal line;
an inversion drive circuit configured to provide a first display signal to the first display signal line and a second display signal to the second display signal line, the first display signal being in phase with the common potential, the second display signal being inverted with respect to the common potential at a predetermined period,
wherein each of the sub-pixels further comprises
a sub-pixel electrode, and
a node to which one piece of the sub-pixel data in the memory brock is output,
a switch circuit coupled to the node and configured to
output a potential based on a potential of the node to the sub-pixel electrode, and
couple the sub-pixel electrode to either one of the first signal line or the second signal line based on the potential of the node.
